(19) United States
(12) Patent Application Publication
(10) Pub. No.: US 2026/0132794 A1
(43) Pub. Date: May 14, 2026

(54) COMPRESSOR

(71) Applicant: SAMSUNG ELECTRONICS CO., LTD., Suwon-si (KR)

(72) Inventors: Kichang LEE, Suwon-si (KR); Hongjoo BAE, Suwon-si (KR); Dongbum LEE, Suwon-si (KR); Jonghyun CHOI, Suwon-si (KR)

(73) Assignee: SAMSUNG ELECTRONICS CO., LTD., Suwon-si (KR)

(21) Appl. No.: 19/373,104

(22) Filed: Oct. 29, 2025

Related U.S. Application Data
(63) Continuation of application No. PCT/KR2025/014357, filed on Sep. 16, 2025.

(30) Foreign Application Priority Data
Nov. 11, 2024 (KR) 10-2024-0159673

(51) Int. Cl. F04D 25/06; F04C 18/02; H01R 13/46; H01R 13/629

(52) U.S. Cl. CPC F04D 25/0693; H01R 13/46; H01R 13/629; F04C 18/0215

(57) ABSTRACT

A compressor includes: a housing, external terminals connectable to an external power source outside the housing, each including a connection plate, and internal terminals inside the housing, each including a terminal holder configured such that the connection plate of a corresponding external terminal of the external terminals is coupled to the terminal holder, and a terminal case inside the housing, and configured to support the internal terminals. The terminal case comprises guide holes, each being configured such that the terminal holder of a corresponding internal terminal of the internal terminals is insertable into the guide hole through one side of the guide hole to be supported by the terminal case, and the connection plate of a corresponding external terminal of the external terminals is insertable into the guide hole through another side of the guide hole to be coupleable to the terminal holder inside the terminal case.

### CROSS-REFERENCE TO RELATED APPLICATIONS

This application is a continuation of International Application No. PCT/KR2025/014357 filed Sep. 16, 2025, and claims foreign priority to Korean Application No. 10-2024-0159673 filed Nov. 11, 2024, and which are incorporated herein by reference in their entireties.

### TECHNICAL FIELD

The present disclosure relates to a compressor.

### BACKGROUND ART

A compressor is a mechanical device for receiving power from a power generation device such as an electric motor or turbine and compressing air, refrigerant, or other working gases to increase pressures. Compressors are widely used in home appliances such as refrigerators, air conditioners, and clothes dryers, or throughout industry.

Types of compressors include reciprocating compressors, scroll compressors, and rotary compressors. A reciprocating compressor compresses a working gas as a piston reciprocates in a straight line inside a cylinder by forming a compression space between the piston and the cylinder, into and from which the working gas is sucked and discharged. A scroll compressor compresses a working gas as an orbiting scroll rotates along a stationary scroll by forming a compression space between the orbiting scroll and the stationary scroll, into and from which the working gas is sucked and discharged. A rotary compressor compresses a working gas as an eccentrically rotating rolling piston rotates eccentrically along an inner wall of a cylinder by forming a compression space between the rolling piston and the cylinder, into and from which the working gas is sucked and discharged.

A compressor includes a compression unit in which compression of a refrigerant is performed, and a driving unit for providing power to compress the refrigerant. The driving unit may include a motor for generating power, and the motor may be powered by an external power source to generate power.

### DISCLOSURE

### Technical Problem

The present disclosure is directed to providing a compressor having an improved structure such that an external terminal and an internal terminal may be firmly coupled.

The present disclosure is directed to providing a compressor having an improved structure such that a process of coupling a plurality of external terminals and a plurality of internal terminals may be performed efficiently.

The present disclosure is directed to providing a compressor having an improved structure such that a process of coupling a plurality of external terminals and a plurality of internal terminals may be automated.

The present disclosure is directed to providing a compressor having an improved structure such that terminals may be protected from foreign substances and high temperatures inside the compressor.

Technical tasks to be achieved in the present disclosure are not limited to the technical tasks mentioned above, and other technical tasks not mentioned will be clearly understood by those skilled in the art from the description below.

### Technical Solution

According to an embodiment of the present disclosure, a compressor may include: a motor, a housing configured to accommodate the motor, a plurality of external terminals connectable to an external power source outside the housing, wherein each of the plurality of external terminals includes a connection plate, a plurality of internal terminals inside the housing and electrically connected to the motor, wherein each of the plurality of internal terminals includes a terminal holder configured such that the connection plate of a corresponding external terminal of the plurality of external terminals is coupled to the terminal holder, and a terminal case inside the housing and configured to support the plurality of internal terminals. The terminal case may include a plurality of guide holes, each guide hole being configured such that the terminal holder of a corresponding internal terminal of the plurality of internal terminals is insertable into the guide hole through one side of the guide hole to be supported by the terminal case, and the connection plate of a corresponding external terminal of the plurality of external terminals is insertable into the guide hole through another side of the guide hole to be coupleable to the terminal holder inside the terminal case.

According to an embodiment of the present disclosure, a compressor may include: a motor, a housing configured to accommodate the motor, a plurality of external terminals connected to an external power source disposed outside the housing, a plurality of internal terminals disposed inside the housing and configured to be connected correspondingly to the plurality of external terminals, and a terminal case disposed inside the housing and configured to support the plurality of internal terminals. Each of the plurality of internal terminals may include an internal terminal lead electrically connected to the motor, and a terminal holder connected to the internal terminal lead and configured such that a corresponding external terminal among the plurality of external terminals is fitted and coupled thereto. The terminal case may include a plurality of guide holes provided such that the terminal holders are inserted thereinto to fix the plurality of internal terminals. The guide hole may be provided such that the plurality of external terminals is insertable from another side so that the plurality of external terminals is coupleable to the terminal holder included in a corresponding internal terminal among the plurality of internal terminals inside the guide hole.

According to an embodiment of the present disclosure, a compressor may include: a housing, a plurality of first terminals fixed to the housing, a plurality of second terminals configured to be connected correspondingly to the plurality of first terminals, and a terminal case configured to accommodate the plurality of second terminals. Each of the plurality of first terminals may include a connection plate. Each of the plurality of second terminals may include a terminal holder configured such that the connection plate of a corresponding first terminal among the plurality of first terminals is fitted and coupled thereto. The terminal case may include a plurality of guide holes configured such that the terminal holder included in each of the plurality of second terminals is inserted thereinto from one side and the connection plate included in each of the plurality of first terminals is inserted thereinto from another side, and the plurality of guide holes may guide the plurality of first terminals so that the connection plates are coupleable to the terminal holders inside the terminal case.

### DESCRIPTION OF DRAWINGS

FIG. 1 is a schematic diagram illustrating an air conditioner including a compressor according to an embodiment of the present disclosure.

FIG. 2 is a view illustrating a compressor and an oil separator according to an embodiment of the present disclosure.

FIG. 3 is a view illustrating a portion of a housing of the compressor according to an embodiment of the present disclosure, including an external terminal, an internal terminal, and a terminal case.

FIG. 4 is a view illustrating the external terminal, the internal terminal, and the terminal case of the compressor according to an embodiment of the present disclosure.

FIG. 5 is a view illustrating a state in which a plurality of the external terminals and a plurality of the internal terminals of the compressor are coupled according to an embodiment of the present disclosure.

FIG. 6 is an enlarged view illustrating a state in which one external terminal among the plurality of external terminals and one internal terminal among the plurality of internal terminals of the compressor are coupled according to an embodiment of the present disclosure.

FIG. 7 is a cross-sectional view illustrating the state in which one external terminal among the plurality of external terminals and one internal terminal among the plurality of internal terminals of the compressor are coupled according to an embodiment of the present disclosure.

FIG. 8 is an exploded view illustrating the internal terminal and the terminal case of the compressor according to an embodiment of the present disclosure.

FIG. 9 is an exploded view illustrating a case body and a case cover of the terminal case of the compressor according to an embodiment of the present disclosure.

FIG. 10 is a view illustrating the case body of the compressor according to an embodiment of the present disclosure as seen from one direction.

FIG. 11 is a view illustrating the case body of the compressor according to an embodiment of the present disclosure as seen from another direction.

FIG. 12 is a cross-sectional view illustrating a state in which the plurality of external terminals and the plurality of internal terminals of the compressor according to an embodiment of the present disclosure are coupled inside the terminal case.

FIG. 13 is a view illustrating for explaining a process of coupling the plurality of internal terminals and the plurality of external terminals of the compressor using assembly tools according to an embodiment of the present disclosure.

FIG. 14 is a view illustrating for explaining a process of coupling the plurality of internal terminals and the plurality of external terminals of the compressor using an assembly tool according to an embodiment of the present disclosure.

FIG. 15 is a view illustrating the terminal case of the compressor and an example of a positioning hole formed thereon according to an embodiment of the present disclosure.

FIG. 16 is a view illustrating the terminal case of the compressor and an example of a positioning hole formed thereon according to an embodiment of the present disclosure.

FIG. 17 is a view illustrating the terminal case of the compressor and an example of a positioning hole formed thereon according to an embodiment of the present disclosure.

FIG. 18 is a view illustrating the terminal case of the compressor and an example of a positioning hole formed thereon according to an embodiment of the present disclosure.

FIG. 19 is a view illustrating the terminal case of the compressor and an example of a positioning hole formed thereon according to an embodiment of the present disclosure.

FIG. 20 is a view illustrating the terminal case of the compressor and an example of a positioning hole formed thereon according to an embodiment of the present disclosure.

FIG. 21 is a view illustrating the terminal case of the compressor and an example of a positioning hole formed thereon according to an embodiment of the present disclosure.

FIG. 22 is a view illustrating the external terminal, the internal terminal, and a terminal case of the compressor according to an embodiment of the present disclosure.

FIG. 23 is an exploded view illustrating the internal terminal and the terminal case of the compressor according to an embodiment of the present disclosure.

FIG. 24 is an exploded view illustrating a case body and a case cover of the terminal case of the compressor according to an embodiment of the present disclosure.

### MODE OF THE DISCLOSURE

Various embodiments of the present disclosure and the terms used therein are not intended to limit the technical features described in the present disclosure to specific embodiments, and should be understood to include various modifications, equivalents, or substitutes of the embodiments.

In connection with the explanation of the drawings, like reference numbers may be used for like or related components.

The singular form of a noun corresponding to an item may include one item or a plurality of items, unless the relevant context clearly dictates otherwise.

In the present disclosure, each of phrases such as “A or B,” “at least one of A and B,” “at least one of A or B,” “A, B or C,” “at least one of A, B and C,” and “at least one of A, B, or C” may include any one of the items listed together in the corresponding one of the phrases, or all possible combinations thereof.

The term “and/or” includes any combination of a plurality of related items or any one of a plurality of related items.

Terms such as “first,” “second,” “primary,” and “secondary” may simply be used to distinguish a given component from other corresponding components, and do not limit the corresponding components in any other aspect (e.g., importance or order).

The terms “comprises” and “has” are intended to indicate that there are features, numbers, steps, operations, components, parts, or combinations thereof described in the present disclosure, and do not exclude the presence or addition of one or more other features, numbers, steps, operations, components, parts, or combinations thereof.

When any component is referred to as being “connected,” “coupled,” “supported” or “in contact” with another component, this includes a case in which the components are indirectly connected, coupled, supported, or in contact with each other through a third component as well as directly connected, coupled, supported, or in contact with each other.

When any component is referred to as being located “on” or “above” another component, this includes not only a case in which any component is in contact with another component but also a case in which another component is present between the two components.

The terms “upper side, “lower side,” “horizontal direction,” etc., used in the description below are defined based on the drawings, and a shape and position of each component are not limited by these terms.

Among the expressions used in the description below, “upper portion˜,” “lower portion˜,” etc., may be used to distinguish components by considering the relative positions between the components, and these expressions may be replaced with expressions such as “first˜” and “second˜”.

Hereinafter, embodiments of the present disclosure will be described in detail with reference to the accompanying drawings.

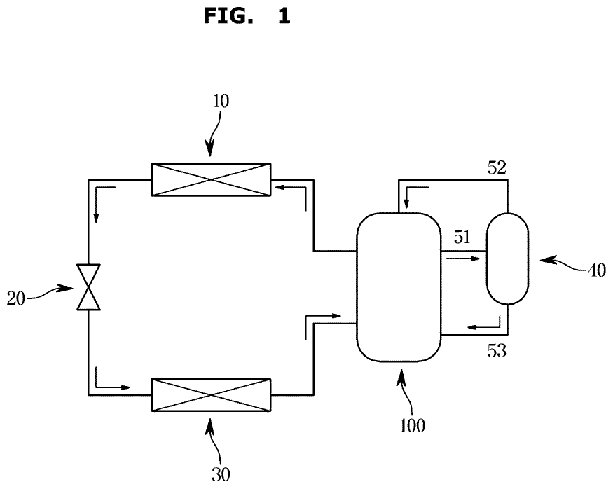

FIG. 1 is a schematic diagram illustrating an air conditioner including a compressor according to an embodiment of the present disclosure.

Referring to FIG. 1, according to an embodiment of the present disclosure, a compressor 100, a condenser 10, an expansion device 20, and an evaporator 30 may be included in a refrigeration cycle device. For example, the refrigeration cycle device may include a refrigerant circulation circuit for exchanging heat via a refrigerant. For example, the refrigeration cycle device may include an air conditioner 1.

The compressor 100 may be configured to compress refrigerant gas. The compressor 100 may be configured to discharge high temperature and high pressure refrigerant gas. The gaseous refrigerant compressed at high temperature and high pressure in the compressor 100 may pass through the condenser 10, the expansion device 20, and the evaporator 30 and then be introduced again into the compressor 100.

The condenser 10 may be configured to exchange heat between the high temperature and high pressure refrigerant gas discharged from the compressor 100 in a high temperature and high pressure state and the air. The condenser 10 may condense refrigerant gas in the high temperature and high pressure state, and the refrigerant condensing while passing through the condenser 10 may release heat to the outside.

The expansion device 20 may be configured to expand the refrigerant discharged from the condenser 10. For example, the expansion device 20 may be configured to expand refrigerant liquid in a high temperature and high pressure state by utilizing the throttling effect. A density and pressure of the refrigerant may be reduced by the expansion device 20, and the expansion device 20 may discharge refrigerant liquid in a low temperature and low pressure state. The expansion device 20 may include an orifice capable of reducing a cross-sectional area of a flow path. The refrigerant may pass through the expansion device 20 and become saturated vapor state in which a pressure is lowered to a state in which it is easy to evaporate in the evaporator 30.

The evaporator 30 may be configured to exchange heat between refrigerant liquid in the low temperature and low pressure state introduced from the expansion device 20 and the air. The evaporator 30 may evaporate the refrigerant in the low temperature and low pressure state, and the refrigerant evaporated while passing through the evaporator 30 may absorb external heat.

The refrigerant gas in the low temperature and low pressure state discharged from the evaporator 30 may be introduced again into the compressor 100 and compressed.

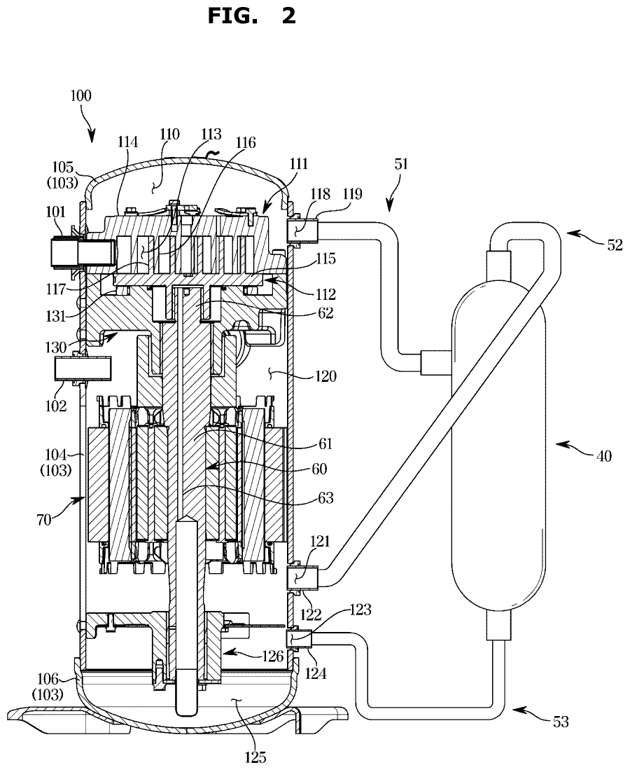

Oil may be provided inside the compressor 100 to ensure a smooth operation of the compressor 100. The oil may reduce friction occurring when the compressor 100 is driven, thereby improving energy efficiency of the compressor 100. The oil may be disposed inside a housing 103 of the compressor 100 (see FIG. 2).

However, a portion of the oil may be mixed with the refrigerant compressed by the compressor 100 and discharged outside the compressor 100. As such, when the oil mixed with the refrigerant is introduced into the condenser 10 or the evaporator 30, heat exchange efficiency of the condenser 10 and the evaporator 30 may decrease.

Therefore, according to an embodiment, the refrigeration cycle device may further include an oil separator 40. The oil separator 40 may be configured to separate oil from the oil-mixed refrigerant discharged from the compressor 100. The oil in a liquid state separated in the oil separator 40 may be guided again to the compressor 100. The refrigerant in a gaseous state separated in the oil separator 40 may be guided again to the compressor 100.

FIG. 2 is a view illustrating a compressor and an oil separator according to an embodiment of the present disclosure.

Referring to FIG. 2, the compressor 100 according to an embodiment of the present disclosure may include the housing 103. Inside the housing 103, a space may be formed to accommodate various components of the compressor 100, such as a stationary scroll 111, an orbiting scroll 112, a motor 70, and a rotating shaft 60. Oil may also be provided inside the housing 103 to reduce friction between the components of the compressor 100. The housing 103 may form an outer appearance of the compressor 100.

The housing 103 may include a housing body 104, an upper cap 105 mounted on an upper portion of the housing body 104, and a lower cap 106 mounted on a lower portion of the housing body 104. As an example, the housing body 104 may have a cylindrical shape with an upper end and a lower end open, and the upper cap 105 and the lower cap 106 may be coupled to the upper and lower ends of the housing body 104, respectively, to seal the inside of the housing 103.

The housing 103 may include a suction pipe 101 configured to allow the refrigerant to be introduced. The housing 103 may include a discharge pipe 102 configured to allow the refrigerant to be discharged.

The compressor 100 may include the stationary scroll 111 and the orbiting scroll 112 configured to compress the refrigerant. The stationary scroll 111 may be fixed inside the housing 103. The orbiting scroll 112 may be configured to orbit relative to the stationary scroll 111. The compressor 100 may include the motor 70 configured to drive the orbiting scroll 112.

The stationary scroll 111 may include a first plate 114 in the shape of a disk, and a stationary wrap 116 extending downward from the first plate 114 and forming a compression chamber 113 together with an orbiting wrap 117, which will be described later.

The orbiting scroll 112 may include a second plate 115 in the shape of a disk disposed to face the first plate 114, and the orbiting wrap 117 extending upward from the second plate 115 and forming the compression chamber 113 together with the stationary wrap 116.

The stationary wrap 116 of the stationary scroll 111 and the orbiting wrap 117 of the orbiting scroll 112 may be interlocked to form the compression chamber 113. The compression chamber 113 may be formed by the stationary scroll 111 and the orbiting scroll 112, and a volume of the compression chamber 113 may be reduced as the orbiting scroll 112 orbits relative to the stationary scroll 111. Accordingly, the refrigerant sucked into the compression chamber 113 may be compressed.

The refrigerant compressed by being introduced into the compression chamber 113 may become a high temperature and high pressure refrigerant and be discharged to the outside of the housing 103. According to an embodiment, the compressor 100 may include a first discharge chamber 110 and a second discharge chamber 120 through which the compressed refrigerant is discharged.

The compressor 100 may include a main frame 130 configured to partition the first discharge chamber 110 and the second discharge chamber 120.

Between the orbiting scroll 112 and the main frame 130, an oldham ring 131 may be provided not to rotate but provided to orbit the orbiting scroll 112.

The main frame 130 and a sub frame 126 are fixed to an upper portion and a lower portion of the inside of the housing 103, respectively, and the motor 70 may be disposed between the main frame 130 and the sub frame 126.

The compressor 100 may include the rotating shaft 60 configured to be rotated by the motor 70. The rotating shaft 60 may be configured to transmit a driving force by the motor 70 to the orbiting scroll 112 by connecting the motor 70 and the orbiting scroll 112.

The rotating shaft 60 may include a main shaft 61 fitted into and coupled to the motor 70 to rotate together with the motor 70, and an eccentric portion 62 provided on an upper portion of the main shaft 61 and having a shaft center eccentric from a shaft center of the main shaft 61.

The rotating shaft 60 may be mounted between the main frame 130 and the sub frame 126 to transmit a rotational force generated from the motor 70 to the orbiting scroll 112.

The rotating shaft 60 may include an oil groove 63 provided to guide oil from an oil storage portion 125 provided in a lower portion of the compressor 100 to the compression chamber 113.

According to an embodiment, the compressor 100 may further include, in addition to the suction pipe 101 and the discharge pipe 102, three holes 118, 121, and 123 and connection parts 119, 122, and 124 connected thereto.

The compressor 100 may include the first hole 118 formed on the first discharge chamber 110. The compressor 100 may include the first connection part 119 inserted into the first hole 118. According to an embodiment, the first connection part 119 may be provided to be inserted into the first hole 118, but, unlike this, the first connection part 119 may be formed integrally with the housing 103 (e.g., the housing body 104). The first discharge chamber 110 and the outside of the compressor 100 may be connected through the first hole 118 and the first connection part 119. Additionally, the oil separator 40 and the first discharge chamber 110 may be connected by connecting one end of a first pipe 51 to the first connection part 119.

The compressor 100 may include the second hole 121 formed on the second discharge chamber 120. The compressor 100 may include the second connection part 122 inserted into the second hole 121. According to an embodiment, the second connection part 122 may be provided to be inserted into the second hole 121, but alternatively, the second connection part 122 may be formed integrally with the housing 103 (e.g., the housing body 104). The second discharge chamber 120 and the outside of the compressor 100 may be connected through the second hole 121 and the second connection part 122. Additionally, the oil separator 40 and the second discharge chamber 120 may be connected by connecting one end of a second pipe 52 to the second connection part 122.

The compressor 100 may include the third hole 123 formed on the second discharge chamber 120. The compressor 100 may also include the third connection part 124 inserted into the third hole 123. The third connection part 124 may be provided to be inserted into the third hole 123, but alternatively, may be formed integrally with the housing 103 (e.g., the housing body 104). The second discharge chamber 120 and the outside of the compressor 100 may be connected through the third hole 123 and the third connection part 124. Additionally, the oil separator 40 and the second discharge chamber 120 may be connected by connecting one end of a third pipe 53 to the third connection part 124.

The first discharge chamber 110 may be connected to the suction pipe 101 and the first pipe 51. The refrigerant introduced through the suction pipe 101 may be compressed in the compression chamber 113 and then discharged to the oil separator 40 through the first pipe 51. In a process of compressing the refrigerant, oil may be mixed with the refrigerant. Accordingly, the refrigerant mixed with oil may be discharged from the compression chamber 113 to the oil separator 40 through the first pipe 51.

The refrigerant and oil separated in the oil separator 40 may be returned to the compressor 100 through the second pipe 52 and the third pipe 53, respectively. The refrigerant gas in the high temperature and high pressure state may be introduced into the second discharge chamber 120 through the second pipe 52 and guided to the condenser 10 through the discharge pipe 102.

The oil in a high temperature state separated in the oil separator 40 may be introduced into the second discharge chamber 120 through the third pipe 53 connected to the third connection part 124 and may be guided to the oil storage portion 125 provided in the lower portion of the compressor 100.

The components of the compressor 100 described above with reference to FIG. 2 are only for explaining one embodiment of the present disclosure, and in various embodiments of the present disclosure, the compressor 100 may include various components for compressing the refrigerant, including the motor 70.

FIG. 2 illustrates that the compressor 100 according to an embodiment is, for example, a scroll type compressor, but the present disclosure is not limited thereto, and in various embodiments, the compressor 100 may include various types of compressors, such as a reciprocating compressor, a rotary compressor, etc.

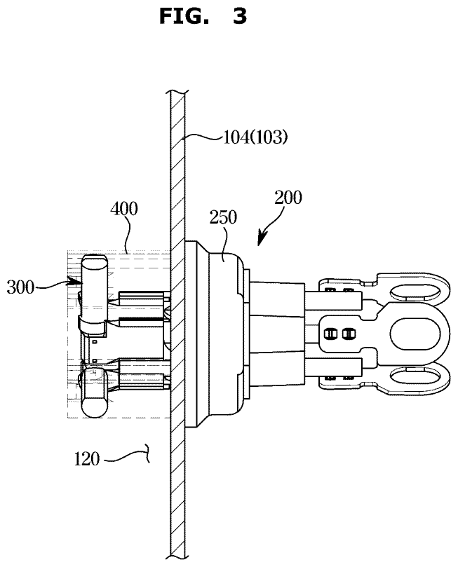

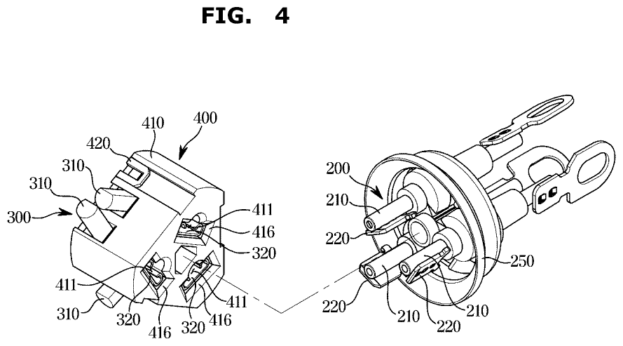

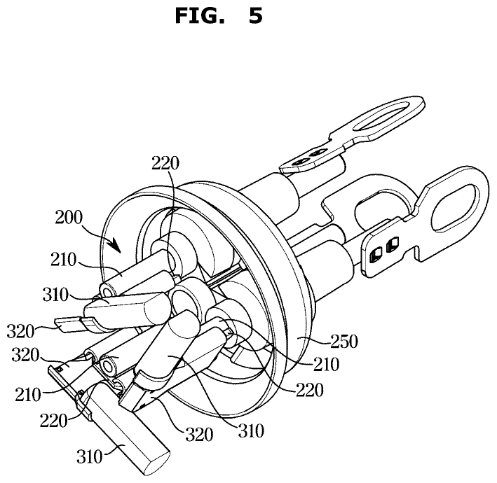

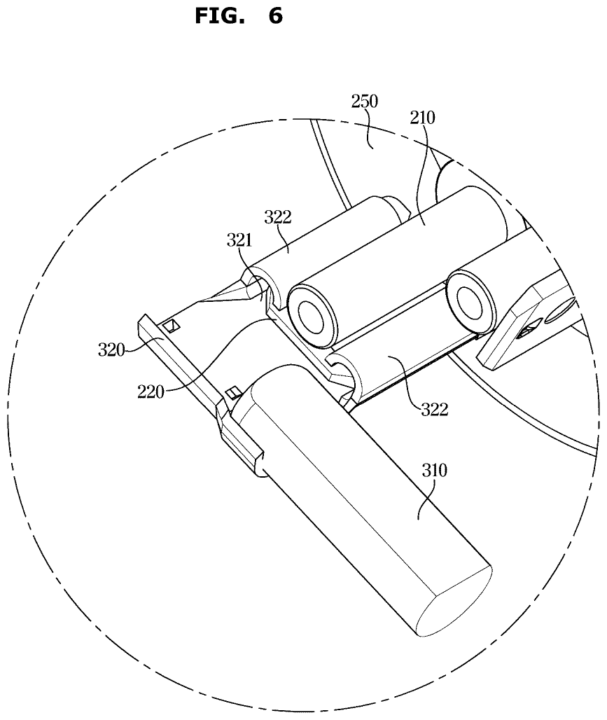

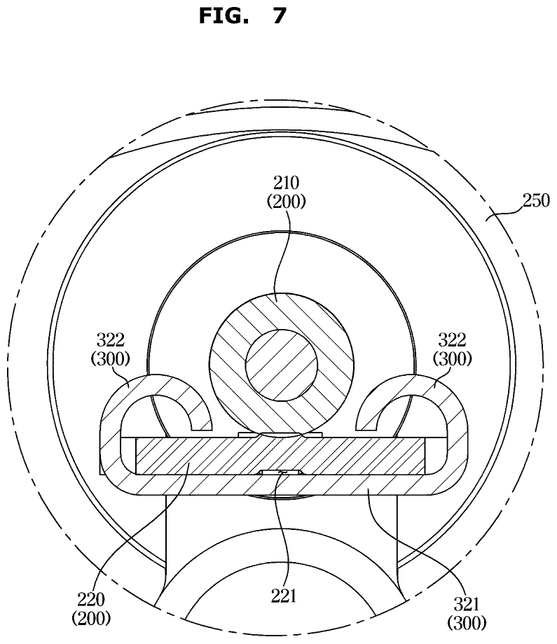

FIG. 3 is a view illustrating a portion of a housing of the compressor according to an embodiment of the present disclosure, including an external terminal, an internal terminal, and a terminal case. FIG. 4 is a view illustrating the external terminal, the internal terminal, and the terminal case of the compressor according to an embodiment of the present disclosure. FIG. 5 is a view illustrating a state in which a plurality of the external terminals and a plurality of the internal terminals of the compressor are coupled according to an embodiment of the present disclosure. FIG. 6 is an enlarged view illustrating a state in which one external terminal among the plurality of external terminals and one internal terminal among the plurality of internal terminals of the compressor are coupled according to an embodiment of the present disclosure. FIG. 7 is a cross-sectional view illustrating the state in which one external terminal among the plurality of external terminals and one internal terminal among the plurality of internal terminals of the compressor are coupled according to an embodiment of the present disclosure.

Referring to FIGS. 3 to 7, the compressor 100 according to one embodiment of the present disclosure may include an external terminal 200 and an internal terminal 300 configured to apply power to a motor 70. The external terminal 200 and the internal terminal 300 may each include various conductive materials such as metal. The external terminal 200 and the internal terminal 300 may also be referred to as a “first terminal” and a “second terminal”, respectively.

The external terminal 200 may be connected to an external power source disposed on the outside of the housing 103. The external power source may include various external power devices to supply power to various components of the compressor 100. The external terminal 200 may be electrically connected to the external power source and may penetrate the housing 103 such that at least a portion of the terminal may be disposed inside the housing 103.

The internal terminal 300 may be disposed inside the housing 103. The internal terminal 300 may be electrically connected to the motor 70. The internal terminal 300 may be electrically connected to the motor 70 through a wire or the like.

The internal terminal 300 may be connected to the external terminal 200. The internal terminal 300 and the external terminal 200 may be connected by being coupled to each other. As the internal terminal 300 and the external terminal 200 are connected to each other, the motor 70 may be supplied with power from an external power source.

The external terminal 200 may include a plurality of the external terminals 200. The plurality of external terminals 200 may be arranged to be spaced apart from each other to be in a state of being electrically isolated from each other.

Correspondingly, the internal terminal 300 may include a plurality of the internal terminals 300. The plurality of internal terminals 300 may be arranged to be spaced apart from each other to be in a state of being electrically isolated from each other.

The plurality of external terminals 200 and the plurality of internal terminals 300 may be arranged to be connected correspondingly to each other. A number of the external terminals 200 and internal terminals 300 may be the same, and may be connected in a one-to-one correspondence. That is, each of the plurality of external terminals 200 may be connected to a corresponding internal terminal among the plurality of internal terminals 300, and each of the plurality of internal terminals 300 may be connected to a corresponding external terminal among the plurality of external terminals 200. The plurality of external terminals 200 and the plurality of internal terminals 300 may be connected in a one-to-one correspondence with each other.

According to an embodiment, the compressor 100 may include the three external terminals 200 connected to the external power source and the three internal terminals 300 connected to the motor 70. Accordingly, three-phase AC power may be supplied to the motor 70.

Each of the plurality of external terminals 200 may include an external terminal lead 210. For example, the one external terminal 200 may include the one external terminal lead 210. The external terminal lead 210 may be connected to the external power source.

At least a portion of the external terminal lead 210 may be disposed inside the housing 103. As an example, a portion of the external terminal lead 210 may be disposed inside the housing 103 and another portion may be disposed outside the housing 103, such that the external terminal lead 210 may pass through the housing 103 and be connected to the external power source. Alternatively, as an example, the entire external terminal lead 210 may be disposed inside the housing 103 and connected to other components such as wires, conductive pins, etc., disposed outside the housing 103, such that the external terminal lead 210 may be connected to the external power source.

As an example, the external terminal lead 210 may have a substantially long bar shape.

Each of the plurality of external terminals 200 may include a connection plate 220. For example, the one external terminal 200 may include the one connection plate 220. The connection plate 220 may be connected to the external terminal lead 210. The connection plate 220 may be coupled to the external terminal lead 210. The connection plate 220 may be supported by the external terminal lead 210.

As an example, the connection plate 220 may have the shape of a plate having a thin thickness. As an example, the connection plate 220 may have a thin thickness in a direction of being in contact with the external terminal lead 210.

The external terminal lead 210 may be in contact with one surface of the connection plate 220. The external terminal lead 210 may be coupled to one surface of the connection plate 220. Herein, the one surface of the connection plate 220 may refer to, for example, one surface of two surfaces in a direction in which the thickness of the connection plate 220 is thin.

The connection plate 220 may be connected to the internal terminal 300. Each of the plurality of external terminals 200 may be connected to a corresponding internal terminal among the plurality of internal terminals 300. Each of the plurality of external terminals 200 may be coupled to a corresponding internal terminal among the plurality of internal terminals 300. Accordingly, the connection plate 220 may connect the internal terminal 300 and the external terminal lead 210.

Each of the plurality of internal terminals 300 may include an internal terminal lead 310. For example, the one internal terminal 300 may include the one internal terminal lead 310. The internal terminal lead 310 may be electrically connected to the motor 70. The internal terminal lead 310 may be electrically connected to the motor 70 through components such as wires.

The internal terminal lead 310 may be disposed inside the housing 103.

As an example, the internal terminal lead 310 may have a substantially long bar shape.

Each of the plurality of internal terminals 300 may include a terminal holder 320. For example, the one internal terminal 300 may include the one terminal holder 320. The terminal holder 320 may be connected to the internal terminal lead 310. The terminal holder 320 may be coupled to the internal terminal lead 310. For example, the terminal holder 320 may be coupled by overing a portion of an outer peripheral surface of internal terminal lead 310. For example, the terminal holder 320 may be coupled to one end of the internal terminal lead 310. For example, the internal terminal lead 310 may be coupled to one end of the terminal holder 320.

The terminal holder 320 may be connected to the connection plate 220. The terminal holder 320 may be coupled to the connection plate 220. The terminal holder 320 of each of the plurality of internal terminals 300 may be coupled to the connection plate 220 of a corresponding external terminal among the plurality of external terminals 200.

According to an embodiment, the connection plate 220 may be fitted into and coupled to the terminal holder 320. The connection plate 220 may be coupled to the terminal holder 320 by being inserted into the terminal holder 320. The terminal holder 320 may be configured to press both the surfaces of the connection plate 220 when the terminal holder 320 and the connection plate 220 are coupled. Herein, both the surfaces of the connection plate 220 may refer to, for example, two surfaces of the connection plate 220 in the direction of thin thickness. Herein, both the surfaces of the connection plate 220 may refer to, for example, two surfaces of the connection plate 220 in a direction of being coupled to the external terminal lead 210.

For example, referring to FIGS. 6 and 7, the terminal holder 320 may include a first contact portion 321 and a second contact portion 322 in contact with both the surfaces of the connection plate 220. The first contact portion 321 may be in contact

with one of both the surfaces of the connection plate 220, and the second contact portion 322 may be in contact with the other of both the surfaces of the connection plate 220. The first contact portion 321 may press one of both the surfaces of the connection plate 220, and the second contact portion 322 may press the other of both the surfaces of the connection plate 220. For example, the second contact portion 322 may be in contact with one surface of the connection plate 220 coupled to the external terminal lead 210, and the first contact portion 321 may be in contact with the other surface of the connection plate 220 opposite thereto.

The first contact portion 321 may have a substantially flat plate shape of being in contact with one surface of the connection plate 220. The second contact portion 322 may have a shape of extending from an edge of the first contact portion 321 and being curved to contact the other surface of the connection plate 220. As an example,

the second contact portion 322 may be provided in plurality, and the plurality of second contact portions 322 may each extend from both edges of the connection plate 220. As an example, the plurality of second contact portions 322 may each extend from both the edges of the first contact portion 321 in a direction perpendicular to a direction in which the connection plate 220 is fitted into the terminal holder 320.

The connection plate 220 may be coupled to the terminal holder 320 by being fitted into the space between the first contact portion 321 and the second contact portion 322.

By this structure, the connection plate 220 may be fitted into the terminal holder 320, and the connection plate 220 and the terminal holder 320 may be firmly coupled to each other.

According to an embodiment, so that the connection plate 220 and the terminal holder 320 may be more firmly coupled to each other, the connection plate 220 may include a recessed portion 221 formed on a surface being in contact with the terminal holder 320. For example, the connection plate 220 may have the recessed portion 221 on one surface being in contact with the first contact portion 321.

Alternatively, according to one embodiment, the terminal holder 320 may include a recessed portion formed on a surface being in contact with the connection plate 220. For example, a recessed portion may be formed on one side of the first contact portion 321 being in contact with the connection plate 220.

By the structure of the connection plate 220 and the terminal holder 320 as described above, the internal terminal 300 and the external terminal 200 may be firmly fitted to each other.

The connection plate 220 and the terminal holder 320 may be coupled to each other only in a fixed direction. In a state in which the connection plate 220 and the terminal holder 320 are coupled to each other, positions thereof may be fixed. For example, the connection plate 220 and the terminal holder 320 may be coupled to each other only in a direction in which the first contact portion 321 comes into contact with a specific surface of the connection plate 220 and the second contact portion 322 comes into contact with a specific other surface of the connection plate 220. For example, in the state in which the connection plate 220 and the terminal holder 320 are coupled, the external terminal lead 210 may be positioned between the plurality of second contact portions 322, and when the connection plate 220 is to be coupled to the terminal holder 320 in the opposite direction, the first contact portion 321 may interfere with the external terminal lead 210, so that the connection plate 220 and the terminal holder 320 may not be coupled to each other.

The connection plate 220 may be fitted on a side different from one side of the terminal holder 320 to which the internal terminal lead 310 is connected. The internal terminal lead 310 may be coupled to the terminal holder 320 on a side opposite to the side on which the connection plate 220 is fitted.

As an example, the terminal holder 320 may extend from one end of the internal terminal lead 310 in a direction different from a direction in which the internal terminal lead 310 extends. As an example, the terminal holder 320 may extend from one end of the internal terminal lead 310 in a direction perpendicular to the direction in which the internal terminal lead 310 extends. However, the present disclosure is not limited thereto, and in various embodiments, a relationship between the extension direction of the terminal holder 320 and the extension direction of the internal terminal lead 310 may be variously provided. For example, the terminal holder 320 may extend from one end of the internal terminal lead 310 in a direction parallel to the direction in which the internal terminal lead 310 extends.

The internal terminal 300 may also be referred to as a “flag terminal”, and the terminal holder 320 may be referred to by various terms, such as a “flag (part)”.

The plurality of external terminals 200 may be fixed to the housing 103. For example, the plurality of external terminals 200 may be supported by an external terminal supporter 250 coupled to an outer wall of the housing 103, thereby being fixed to the housing 103. The plurality of external terminals 200 may be connected to the external power source and the plurality of respective internal terminals 300 by penetrate the external terminal supporter 250. For example, the external terminal lead 210 of each of the plurality of external terminals 200 may penetrate the external terminal supporter 250.

The plurality of internal terminals 300 may be supported by the plurality of external terminals 200 fixed to the housing 103 by being coupled to the plurality of external terminals 200.

According to an embodiment, the compressor 100 may include a terminal case 400. The terminal case 400 may be disposed inside the housing 103. The terminal case 400 may support the plurality of internal terminals 300. The terminal case 400 may cover the plurality of internal terminals 300. The terminal case 400 may accommodate the plurality of internal terminals 300.

The terminal holder 320 of each of the plurality of internal terminals 300 may be disposed inside the terminal case 400. The terminal case 400 may cover the terminal holder 320 of each of the plurality of internal terminals 300.

When the terminal holder 320 and the connection plate 220 are coupled, the connection plate 220 may be disposed inside the terminal case 400. When the terminal holder 320 and the connection plate 220 are coupled, the terminal case 400 may cover the connection plate 220. The connection plate 220 of each of the plurality of external terminals 200 and the terminal holder 320 of each of the plurality of internal terminals 300 may be coupled to each other inside the terminal case 400.

Accordingly, the terminal case 400 may protect the plurality of external terminals 200 and the plurality of internal terminals 300 from high temperatures inside the housing 103 or foreign substances inside the housing 103 (e.g., oil, refrigerant, dust, metal powder from components of the compressor 100, etc.) during operation of the compressor 100.

Hereinafter, the structure and function of the terminal case 400 will be described in more detail.

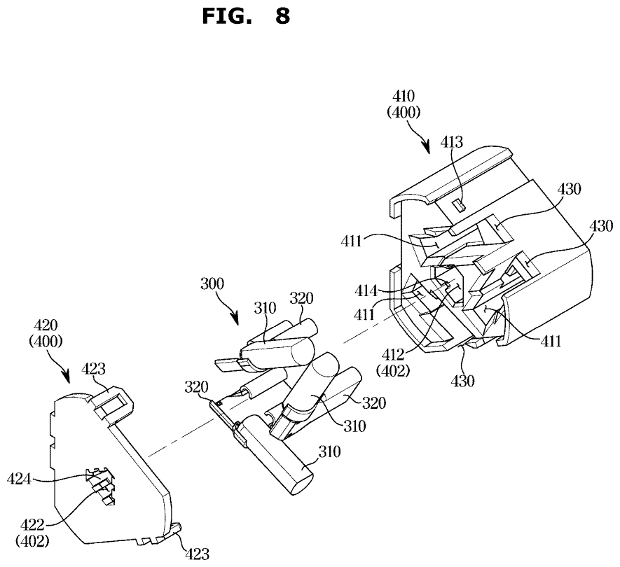

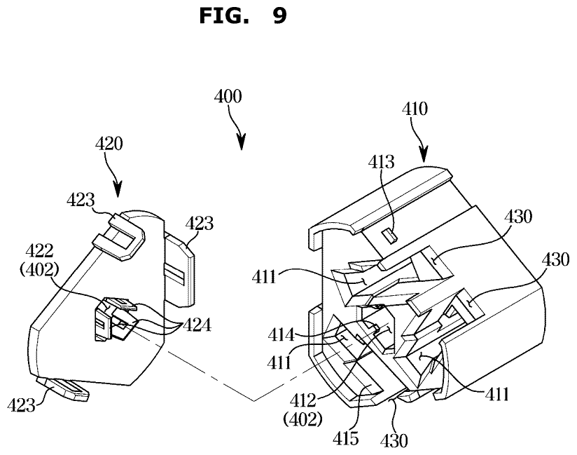

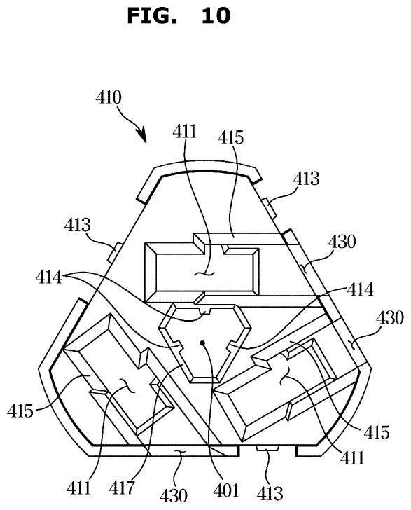

FIG. 8 is an exploded view illustrating the internal terminal and the terminal case of the compressor according to an embodiment of the present disclosure. FIG. 9 is an exploded view illustrating a case body and a case cover of the terminal case of the compressor according to an embodiment of the present disclosure. FIG. 10 is a view illustrating the case body of the compressor according to an embodiment of the present

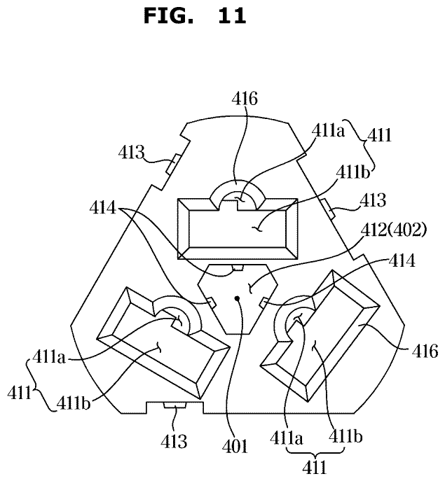

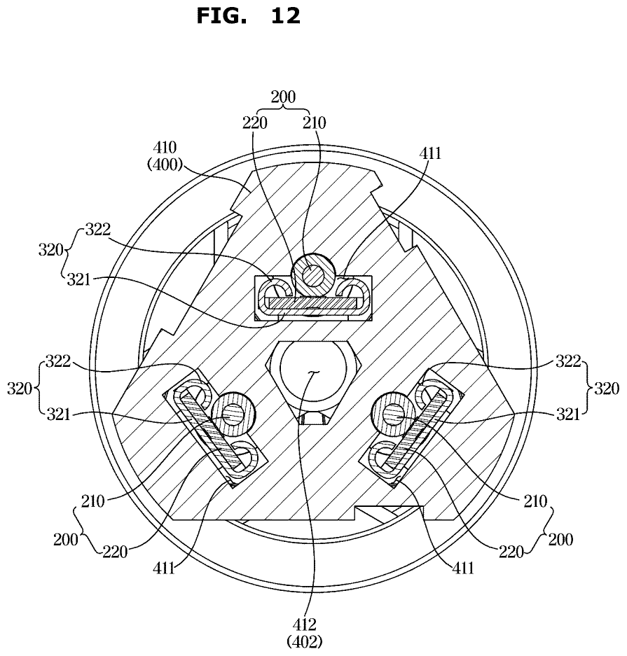

disclosure as seen from one direction. FIG. 11 is a view illustrating the case body of the compressor according to an embodiment of the present disclosure as seen from another direction. FIG. 12 is a cross-sectional view illustrating a state in which the plurality of external terminals and the plurality of internal terminals of the compressor according to an embodiment of the present disclosure are coupled inside the terminal case.

Referring to FIGS. 8 to 12, the terminal case 400 may include a guide hole 411. The guide hole 411 may be provided such that the terminal holder 320 included in each of the plurality of internal terminals 300 may be inserted therein. The guide hole 411 may be provided such that the connection plate 220 included in each of the plurality of external terminals 200 may be inserted therein. For example, the terminal holder 320 may be inserted into one side of the guide hole 411, and the connection plate 220 may be inserted into the other side of the guide hole 411.

As the terminal holder 320 is inserted into the guide hole 411, the internal terminal 300 may be coupled to the terminal case 400. As the connection plate 220 is inserted into the guide hole 411, the external terminal 200 may be coupled to the terminal case 400.

The guide hole 411 may be provided in plurality. In each of a plurality of the guide holes 411, the connection plate 220 of one external terminal among the plurality of external terminals 200 and the terminal holder 320 of one internal terminal of among the plurality of internal terminals 300 may be inserted. A number of the guide holes 411 may be equal to the number of the external terminals 200 and a number of the internal terminals 300, for example, the terminal case 400 may include the three guide holes 411.

One sides on which the terminal holders 320 of the plurality of internal terminals 300 are inserted into the plurality of guide holes 411, respectively, may be equal to each other. The other sides on which the connection plates 220 of the plurality of external terminals 200 are inserted into the plurality of guide holes 411, respectively, may be equal to each other.

The guide hole 411 may be provided such that the connection plate 220 and the terminal holder 320 is combinable with each other inside the terminal case 400. The plurality of guide holes 411 may each guide the terminal holders 320 so that the terminal holders 320 of the plurality of internal terminals 300 may be inserted therein. Each of the plurality of guide holes 411 may guide the connection plate 220 of each of the plurality of external terminals 200 so that the connection plate 220 may be inserted into the guide hole 411 and combinable with the terminal holder 320.

As such, as the connection plate 220 and the terminal holder 320 are coupled to each other inside the guide hole 411 formed inside the terminal case 400, the connection plate 220 and the terminal holder 320 may be effectively protected from external high temperatures or foreign substances.

The terminal case 400 may include inclined surfaces 415 and 416 provided on a perimeter of the guide hole 411. The inclined surfaces 415 and 416 may be provided to guide the insertion of the terminal holder 320 and the connection plate 220, respectively.

The terminal case 400 may include the first inclined surface 415 formed on a side in a direction in which the terminal holder 320 is inserted into the guide hole 411. The first inclined surface 415 of the guide hole 411 may be formed on a side adjacent to a case cover 420, which will be described later. The first inclined surface 415 may be formed such that a width of the guide hole 411 becomes narrower as the terminal holder 320 directs to the direction of being inserted into the guide hole 411. The inclined surface 415 may guide the terminal holder 320 to be inserted into the guide hole 411, and a portion of the terminal holder 320 passed through the inclined surface 415 and then inserted into the guide hole 411 may be more firmly supported and fixed by the terminal case 400 inside the guide hole 411.

The terminal case 400 may include the second inclined surface 416 formed on a side in a direction in which the connection plate 220 is inserted into the guide hole 411 (see FIG. 4). The second inclined surface 416 of the guide hole 411 may be formed on a side adjacent to an inner wall of the housing 103. The second inclined surface 416 may be formed such that the width of the guide hole 411 becomes narrower as the connection plate 220 directs to the direction of being inserted into the guide hole 411. The second inclined surface 416 may guide the connection plate 220 to be inserted into the guide hole 411.

The plurality of guide holes 411 may be partitioned from each other. Accordingly, the terminal holder 320 and the connection plate 220 inserted into the guide holes 411 different from each other may be spaced apart from each other, and occurrence of shorts due to contact between terminals inserted into the different guide holes 411 may be effectively prevented.

According to an embodiment, each of the plurality of guide holes 411 may be spaced apart from a central axis 401 of the terminal case 400. As an example, each of the plurality of guide holes 411 may be spaced apart from a positioning hole 402 provided on the central axis 401 of the terminal case 400, which will be described later. The central axis 401 of the terminal case 400 may be defined as an axis passing through a center of the terminal case 400 in a direction in which the terminal holder 320 and the connection plate 220 are inserted into the guide hole 411.

According to an embodiment, the terminal holder 320 may be fixed inside the guide hole 411. The guide hole 411 may be formed to prevent the terminal holder 320 from moving inside the guide hole 411. Inside the guide hole 411, the terminal holder 320 may be prevented from moving by being in contact with an inner surface of the terminal case 400 in at least two directions. Accordingly, the terminal holder 320 and the connection plate 220 may be easily coupled only by inserting the connection plate 220 into the guide hole 411 into which the terminal holder 320 is inserted.

As such, the plurality of guide holes 411 may be formed in the terminal case 400, the terminal holder 320 may be inserted into and fixed to each of the plurality of

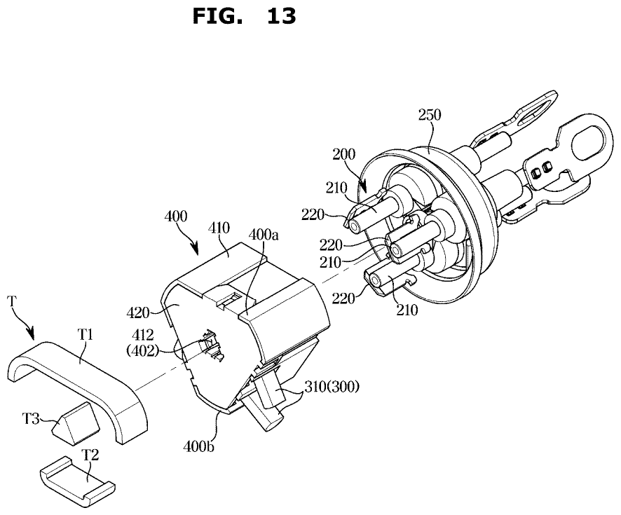

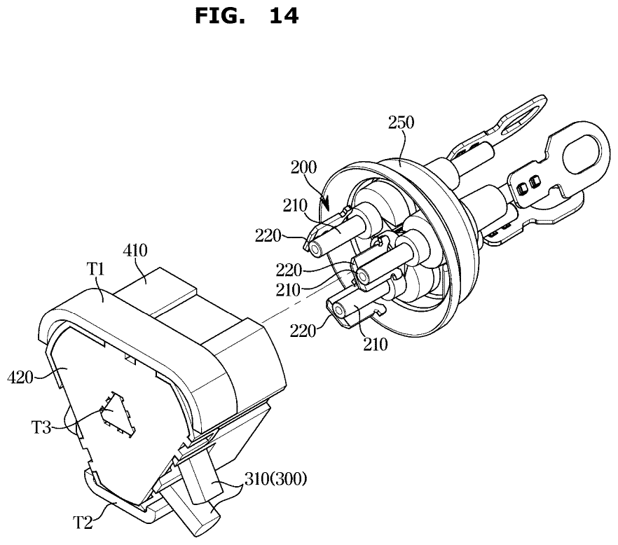

guide holes 411, and the connection plate 220 of each of the plurality of external terminals 200 may be inserted into the corresponding guide hole 411 and guided to be coupled to the terminal holder 320 inserted therein. Accordingly, it is possible for the plurality of external terminals 200 and the plurality of internal terminals 300 to be simultaneously coupled, and the coupling process may be performed easily and efficiently. Furthermore, as illustrated in FIGS. 13 and 14, the process of coupling the plurality of external terminals 200 and the plurality of internal terminals 300 may be easily automated.

According to an embodiment, when the connection plate 220 is inserted into the guide hole 411, at least a portion of the external terminal lead 210 may also be inserted into the guide hole 411. For example, the external terminal lead 210 may penetrate one surface of a side of the terminal case 400 adjacent to the housing 103 and be inserted into the guide hole 411.

According to an embodiment, the internal terminal lead 310 may penetrate the terminal case 400. The terminal case 400 may include an internal terminal lead hole 430 penetrated by the internal terminal lead 310. The internal terminal lead hole 430 may be connected to the guide hole 411. The guide hole 411 may extend from the internal terminal lead hole 430.

For example, the internal terminal lead hole 430 may be formed on a case body 410, which will be described later. The internal terminal lead hole 430 may be formed on a peripheral surface of the case body 410. Herein, the peripheral surface of the case body 410 may include a peripheral surface of the case body 410 directing to a direction different from the direction into which the terminal holder 320 and the connection plate 220 are inserted.

The internal terminal lead hole 430 may extend in one direction from the peripheral surface of the case body 410 toward the inside of the case body 410. The guide hole 411 may extend from an inner end of the internal terminal lead hole 430, and a direction in which the internal terminal lead hole 430 extends from the peripheral surface of the case body 410 and a direction in which the guide hole 411 extends from the internal terminal lead hole 430 may be perpendicular to each other. For example, the direction in which the internal terminal lead hole 430 extends from the peripheral surface of the case body 410 and the direction in which the guide hole 411 extends from the internal terminal lead hole 430 may be substantially perpendicular.

The terminal case 400 may include the internal terminal lead holes 430 of a number (e.g., three) corresponding to the number of the external terminals 200. As an example, a plurality of the internal terminal lead holes 430 may be spaced apart and partitioned from each other.

According to an embodiment, the terminal case 400 may include the case body 410 and the case cover 420.

The case body 410 may be configured to support the plurality of internal terminals 300. The guide hole 411 may be formed on the case body 410. That is, the plurality of guide holes 411 may be formed on the case body 410.

The plurality of guide holes 411 may extend from one surface of the case body 410 adjacent to the case cover 420 to the other surface. The terminal holder 320 may be inserted into one side adjacent to the case cover 420, and the connection plate 220 may be inserted into the opposite side.

The case cover 420 may cover the case body 410. The case cover 420 may cover the case body 410 from one side. The case cover 420 may cover the plurality of guide holes 411. The case cover 420 may cover the terminal holder 320 of each of the plurality of internal terminals 300.

The case cover 420 may cover the case body 410, the plurality of guide holes 411, and the terminal holder 320 of each of the plurality of internal terminals 300 from one side where the terminal holders 320 are inserted into the plurality of guide holes 411. The case cover 420 may cover the case body 410, the plurality of guide holes 411 and the terminal holder 320 of each of the plurality of internal terminals 300 from a side opposite to the inner wall of the housing 103. The case cover 420 may cover the case body 410, the plurality of guide holes 411 and the terminal holder 320 of each of the plurality of internal terminals 300 from a side opposite to the connection plate 220.

The case cover 420 may also cover at least a portion of the internal terminal lead 310 of each of the plurality of internal terminals 300.

The case cover 420 may be coupled to the case body 410. The case cover 420 may cover the case body 410, the plurality of guide holes 411, and the terminal holders 320 of the plurality of internal terminals 300 by being coupled to the case body 410.

For example, the case cover 420 may be coupled to the case body 410 from the outside. An outer coupling part 423 of the case cover 420 may be coupled to an outer coupling part 413 formed on the peripheral surface of the case body 410. As an example, the outer coupling part 413 of the case body 410 may have a protrusion shape of protruding from the peripheral surface of the case body 410 to be caught on a hole formed on the outer coupling part 423 of the case cover 420, so that the case body 410 and the case cover 420 may be coupled to each other.

As an example, the outer coupling part 423 of the case cover 420 may come into contact with the peripheral surface of the case body 410.

For example, the case cover 420 may be coupled inside the case body 410. An inner coupling part 424 of the case cover 420 may be formed on a perimeter of a cover positioning hole 422, which will be described later, and may be coupled to an inner coupling part 414 formed on a perimeter of a body positioning hole 412 of the case body 410, which will be described later. As an example, the inner coupling part 414 of the case body 410 may have a protrusion shape of protruding from the perimeter of the body positioning hole 412 to be caught on a hole formed on the inner coupling part 424 of the case cover 420, so that the case body 410 and the case cover 420 may be coupled to each other.

As an example, the inner coupling part 424 of the case cover 420 may extend to be inserted into the body positioning hole 412 to come into contact with a peripheral surface of the body positioning hole 412.

As an example, a third inclined surface 417 may be formed on the perimeter of the body positioning hole 412 to guide the insertion of the inner coupling part 424 of the case cover 420. The third inclined surface 417 may be formed on one surface of the case body 410 adjacent to the case cover 420. The third inclined surface 417 may be inclined such that a width of the body positioning hole 412 becomes narrower as the inner coupling part 424 of the case cover 420 directs to a direction of being inserted into the body positioning hole 412.

However, the configuration for coupling the case cover 420 and the case body 410 is not limited thereto, and according to various embodiments, the case cover 420 may be coupled to the case body 410 by various methods, such as screw fastening.

According to an embodiment, a thickness of the case cover 420 may be thinner than a thickness of the case body 410. Herein, the thickness may be a thickness measured in a direction in which the case cover 420 and the case body 410 face each other, which may be substantially the same as a thickness measured in a direction in which the terminal holder 320 is inserted into the guide hole 411.

As such, the terminal case 400 may include the case body 410 and the case cover 420, the guide hole 411 may be formed on the case body 410, and the case cover 420 may cover the guide hole 411 and the terminal holder 320 inserted thereinto by being coupled to the case body 410, so that the plurality of external terminals 200 and the plurality of internal terminals 300 may be more effectively protected from high

temperatures and foreign substances inside the housing 103. In addition, by this configuration, processes of inserting the terminal holders 320 of the plurality of internal terminals 300 into the guide holes 411 of the terminal case 400 and coupling the plurality of internal terminals 300 to the terminal case 400 may be performed easily and more efficiently.

As described above, the plurality of external terminals 200 and the plurality of internal terminals 300 may be connected in the one-to-one correspondence with each other. In this case, the terminals corresponding with each other may be predetermined, and a connection defect may occur when terminals non-corresponding with each other are connected to each other.

Therefore, according to an embodiment, the plurality of external terminals 200, the plurality of internal terminals 300, and the terminal case 400 guiding and supporting these terminals may be configured such that the plurality of external terminals 200 and the plurality of internal terminals 300 may be connectable to each other when intended to be connected in a predetermined corresponding relationship, and such that the plurality of external terminals 200 and the plurality of internal terminals 300 may not be connectable to each other when caused to be incorrectly connected in a relationship different from the above corresponding relationship. Accordingly, a defect in the connection of the plurality of external terminals 200 and the plurality of internal terminals 300 may be prevented.

In order to implement this function, based on the terminal case 400 being positioned at one predetermined position (hereinafter referred to as a “first position”) with respect to the plurality of external terminals 200, the terminal holders 320 of the plurality of internal terminals 300 inserted into the plurality of guide holes 411 and the connection plates 220 of the plurality of external terminals 200 may be correspondingly combinable with each other. For example, based on the terminal case 400 being positioned at a first position with respect to the plurality of external terminals 200, the connection plate 220 of each of the plurality of external terminals 200 may be correspondingly positioned to be insertable into a corresponding guide hole among the plurality of guide holes 411 (i.e., the guide hole 411 into which the terminal holder 320 of a corresponding internal terminal among the plurality of internal terminals 300 is inserted).

Unlike this, based on the terminal case 400 being positioned at a position rotated from the first position with respect to the plurality of external terminals 200 (hereinafter referred to as a “second position”, and an angle between the first position and the second position is greater than 0 degrees and less than 360 degrees), the terminal holder 320 of each of the plurality of internal terminals 300 inserted into the plurality of guide holes 411 may be disposed to be misaligned with the connection plate 220 of each of the plurality of external terminals 200. For example, based on the terminal case 400 being positioned at the second position with respect to the plurality of external terminals 200, the connection plate 220 of each of the plurality of external terminals 200 may be disposed to be misaligned so as not to be inserted into each of the plurality of guide holes 411.

That is, the plurality of external terminals 200 may be inserted into the plurality of guide holes 411 and coupled to the plurality of internal terminals 300 only when the terminal case 400 is in the one predetermined first position with respect to the plurality of external terminals 200, and other than that, the plurality of external terminals 200 may not be insertable into the plurality of guide holes 411, and the plurality of external terminals 200 may not be combinable with the plurality of internal terminals 300.

Each of the plurality of guide holes 411 may include a lead region 411a into which the external terminal lead 210 is inserted, and a connection region 411b into which the terminal holder 320 and the connection plate 220 are inserted and connected to each other. When the terminal holder 320 and the connection plate 220 are coupled inside the guide hole 411, the external terminal lead 210 may be disposed in the lead region 411a of the guide hole 411, and the terminal holder 320 and the connection plate 220 may be disposed in the connection region 411b of the guide hole 411.

In each of the plurality of guide holes 411, the lead region 411a and the connection region 411b may be connected to each other. However, in each of the plurality of guide holes 411, the lead region 411a and the connection region 411b may have different widths and shapes. For example, the lead region 411a may have a width and shape corresponding to at least a portion of the external terminal lead 210, and the connection region 411b may have a width and shape corresponding to the terminal holder 320. Therefore, the external terminal lead 210 may be inserted into the lead region 411a, but the terminal holder 320 and connection plate 220 may not be inserted thereinto. Likewise, the terminal holder 320 and connection plate 220 may be inserted into the connection region 411b, but the external terminal lead 210 may not be inserted thereinto.

As illustrated in FIG. 11, in some holes among the plurality of guide holes 411, the connection region 411b may be closer to the central axis 401 of the terminal case 400 than the lead region 411a. Also, in the other some holes among the plurality of guide holes 411, the lead region 411a may be closer to the central axis 401 of the terminal case 400 than the connection region 411b. In this case, as illustrated in FIG. 12, in some of the plurality of external terminals 200, when the external terminal lead 210 and the connection plate 220 are inserted into the guide hole 411, the connection plate 220 may be closer to the central axis 401 of the terminal case 400 than the external terminal lead 210, and in some other of the plurality of external terminals 200, when the external terminal lead 210 and the connection plate 220 are inserted into the guide hole 411, the external terminal lead 210 may be closer to the central axis 401 of the terminal case 400 than the connection plate 220.

Therefore, the connection plate 220 and the external terminal lead 210 may be inserted into the guide hole 411 only when the terminal case 400 is in the one predetermined first position with respect to the plurality of external terminals 200. That is, the plurality of external terminals 200 and the plurality of internal terminals 300 may be connected to each other only when the terminal case 400 is in the one predetermined first position with respect to the plurality of external terminals 200. Accordingly, cases in which the plurality of external terminals 200 and the plurality of internal terminals 300 are incorrectly connected to each other to occur the connection defect may be prevented.

FIGS. 11 and 12 illustrate, as an example, a case in which the connection region 411b in one guide hole of a plurality of guide holes 411 is closer to the central axis 401 of the terminal case 400 than the lead region 411a, and the lead regions 411a in two guide holes of the plurality of guide holes 411 are closer to the central axis 401 of the terminal case 400 than the connection regions 411b, but is not limited thereto. Unlike this, in various embodiments, the connection regions 411b in two guide holes of the plurality of guide holes 411 may be closer to the central axis 401 of the terminal case 400 than the lead regions 411a, and the lead region 411a in one guide hole of the plurality of guide holes 411 may be closer to the central axis 401 of the terminal case 400 than the connection region 411b.

In addition, in various embodiments, each of the plurality of external terminals 200 may be insertable into the guide hole 411 only when the terminal case 400 is in the first position with respect to the plurality of external terminals 200 so that the plurality of external terminals 200 and the plurality of internal terminals 300 may be connected to each other, and the terminal case 400 may, in other cases, have various structures of preventing each of the plurality of external terminals 200 from being inserted into the guide hole 411 such that the plurality of external terminals 200 and the plurality of internal terminals 300 are not connected to each other.

In order to improve the efficiency of a process of connecting the external terminal 200 and the internal terminal 300, the terminal case 400 may include the positioning hole 402. The positioning hole 402 may be provided such that an assembly tool T (see FIGS. 13 and 14) is inserted into the positioning hole 402 to guide the terminal case 400 to the first position with respect to the plurality of external terminals 200.

For example, the assembly tool T may include a positioning pin T3 provided to be inserted into the positioning hole 402, and the positioning pin T3 may have a shape corresponding to the positioning hole 402 to be insertable into the positioning hole 402 only at a specific position (e.g., at a specific angle) with respect to the terminal case 400 (see FIGS. 13 and 14).

As illustrated, the positioning hole 402 may have a cross-section of a polygonal shape, such as a pentagon. Alternatively, the positioning hole 402 may have cross-sections of various shapes in which a distance from the central axis 401 of the terminal case 400 to a perimeter changes depending on positions. Herein, the cross-section of the positioning hole 402 may be defined as a surface in which the positioning hole 402 is cut in a direction perpendicular to a direction in which the assembly tool T is inserted into the positioning hole 402.

As an example, the positioning hole 402 may be located at the center of the terminal case 400, but the location of the positioning hole 402 is not limited thereto.

The positioning hole 402 may include the cover positioning hole 422 formed on the case cover 420 and the body positioning hole 412 formed on the case body 410. The cover positioning hole 422 and the body positioning hole 412 may be disposed at positions corresponding to each other. The cover positioning hole 422 and the body positioning hole 412 may have shapes corresponding to each other.

As an example, the cover positioning hole 422 may extend from one surface of the case cover 420 opposite the case body 410 to the other surface. That is, the cover positioning hole 422 may penetrate the case cover 420. Unlike this, the cover positioning hole 422 may have a shape of a concave groove of extending from one surface of the case cover 420 opposite the case body 410 but of not completely penetrating the case cover 420.

As an example, the body positioning hole 412 may extend from one surface of the case body 410 adjacent to the case cover 420 to the other surface. That is, the body positioning hole 412 may penetrate the case body 410. Unlike this, the body positioning hole 412 may have the shape of a concave groove of extending from one surface of the case body 410 adjacent to the case cover 420 but of not completely penetrating the case body 410.

Unlike this, the positioning hole 402 may be formed only on the case cover 420 and not be formed on the case body 410.

Hereinafter, an example of a method of connecting the plurality of external terminals 200 and the plurality of internal terminals 300 to each other using the assembly tool T will be described with reference to FIGS. 13 and 14.

FIG. 13 is a view illustrating for explaining a process of coupling the plurality of internal terminals and the plurality of external terminals of the compressor using assembly tools according to an embodiment of the present disclosure. FIG. 14 is a view illustrating for explaining a process of coupling the plurality of internal terminals and the plurality of external terminals of the compressor using an assembly tool according to an embodiment of the present disclosure.

Referring to FIGS. 13 and 14, in a process of manufacturing the compressor 100 according to an embodiment of the present disclosure, the process of coupling the plurality of internal terminals 300 and the plurality of external terminals 200 may be performed using the assembly tool T.

The assembly tool T may include a first case holder T1 and a second case holder T2 configured to hold and move the terminal case 400. The first case holder T1 and the second case holder T2 may be configured to hold the terminal case 400 by supporting an outer surface of the terminal case 400 at different positions. For example, the first case holder T1 and the second case holder T2 may be configured to hold the terminal case 400 by pressing the terminal case 400 in opposite directions. For example, the first case holder T1 may press the terminal case 400 downward in a state of covering at least a portion of an upper surface 400a of the terminal case 400, and the second case holder T2 may press the terminal case 400 upward in a state of covering at least a portion of a lower surface 400b of the terminal case 400. Accordingly, the first case holder T1 and the second case holder T2 together may hold and move the terminal case 400.

When the first case holder T1 and the second case holder T2 hold the terminal case 400, the positioning pin T3 of the assembly tool T may be inserted into the positioning hole 402 of the terminal case 400. Accordingly, the terminal case 400 may be guided to the predetermined first position with respect to the plurality of external terminals 200.

The assembly tool T may move toward the plurality of external terminals 200 fixed to the housing 103 in a state of holding the terminal case 400. Thereafter, the assembly tool T may press the case cover 420 in a direction from the case cover 420 toward the case body 410, and the plurality of external terminals 200 may be inserted into the corresponding guide holes 411, respectively. Accordingly, the plurality of external terminals 200 and the plurality of internal terminals 300 may be coupled and connected to each other.

When the process of connecting the plurality of external terminals 200 and the plurality of internal terminals 300 is completed, the assembly tool T may be separated from the terminal case 400.

According to an embodiment, the process of connecting the plurality of internal terminals 300 and the plurality of external terminals 200 using the assembly tool T as described above may be performed by an automated system.

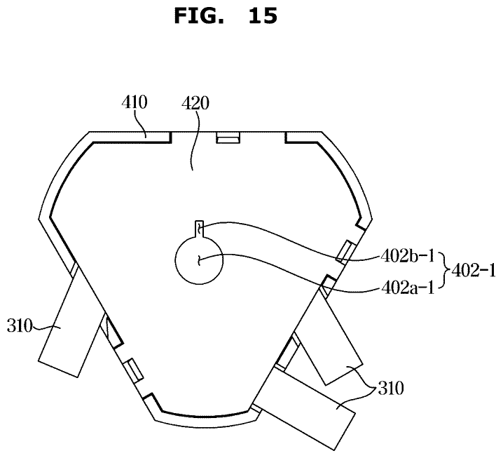

Hereinafter, positioning holes of various shapes formed on the terminal case 400 will be described as examples with reference to FIGS. 15 to 21.

FIG. 15 is a view illustrating the terminal case of the compressor and an example of a positioning hole formed thereon according to an embodiment of the present disclosure.

Referring to FIG. 15, the terminal case 400 of the compressor 100 according to an embodiment of the present disclosure may include a positioning hole 402-1.

The positioning hole 402-1 may include a central hole 402a-1 and a single extension hole 402b-1 extending from the central hole 402a-1. The central hole 402a-1 and the extension hole 402b-1 may be connected to each other.

As an example, the central hole 402a-1 may be formed in the center of the terminal case 400. As an example, the central hole 402a-1 may pass through the central axis 401 of the terminal case 400 (see FIG. 10, FIG. 11, etc.).

As an example, the central hole 402a-1 may have a substantially circular cross-section. Unlike that illustrated in FIG. 15, the central hole 402a-1 may have a substantially elliptical cross-section.

As an example, the extension hole 402b-1 may have a substantially rectangular cross-section. Alternatively, the extension hole 402b-1 may have a cross-section in the shape of a long bar extending from the central hole 402a-1.

By this structure, the positioning pin T3 of the assembly tool T may be inserted into the positioning hole 402-1 only at a specific position, and efficiently guide the terminal case 400 to the first position with respect to the plurality of external terminals 200.

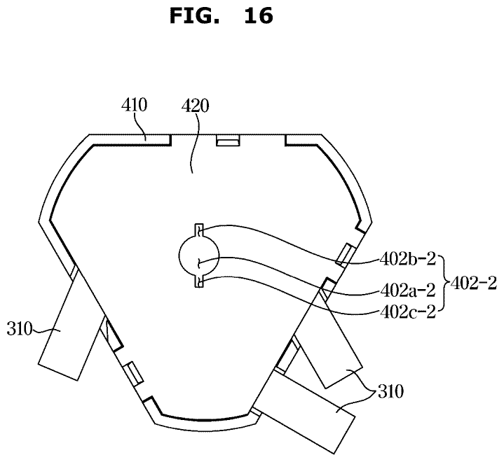

FIG. 16 is a view illustrating the terminal case of the compressor and an example of a positioning hole formed thereon according to an embodiment of the present disclosure.

Referring to FIG. 16, the terminal case 400 of the compressor 100 according to an embodiment of the present disclosure may include a positioning hole 402-2.

The positioning hole 402-2 may include a central hole 402a-2, a first extension hole 402b-2 extending from the central hole 402a-2, and a second extension hole 402c-2 extending from the central hole 402a-2. The central hole 402a-2, the first extension hole 402b-2, and the second extension hole 402c-2 may be connected to each other.

The first extension hole 402b-2 and the second extension hole 402c-2 may be arranged on opposite sides based on the central hole 402a-2. A direction in which the first extension hole 402b-2 extends from the central hole 402a-2 and a direction in which the second extension hole 402c-2 extends from the central hole 402a-2 may be opposite to each other.

As an example, the central hole 402a-2 may be formed in the center of the terminal case 400. As an example, the central hole 402a-2 may pass through the central axis 401 of the terminal case 400 (see FIG. 10, FIG. 11, etc.).

As an example, the central hole 402a-2 may have a substantially circular cross-section. Unlike that illustrated in FIG. 16, the central hole 402a-2 may have a substantially elliptical cross-section.

As an example, the first extension hole 402b-2 may have a substantially rectangular cross-section. Alternatively, the first extension hole 402b-2 may have a cross-section in the shape of a long bar extending from the central hole 402a-2.

As an example, the second extension hole 402c-2 may have a substantially rectangular cross-section. Alternatively, the second extension hole 402c-2 may have a cross-section in the shape of a long bar extending from the central hole 402a-2.

By this structure, the positioning pin T3 of the assembly tool T may be inserted into the positioning hole 402-2 only at a specific position, and efficiently guide the terminal case 400 to the first position with respect to the plurality of external terminals 200.

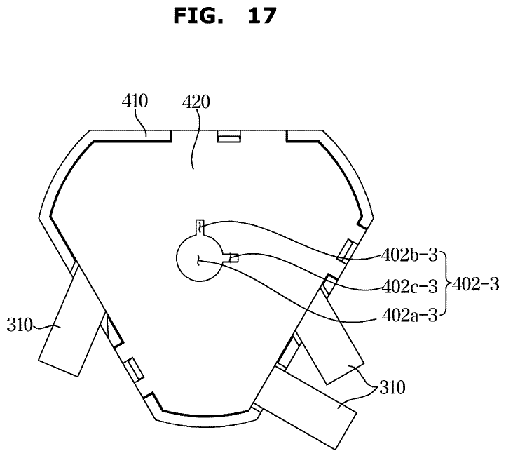

FIG. 17 is a view illustrating the terminal case of the compressor and an example of a positioning hole formed thereon according to an embodiment of the present disclosure.

Referring to FIG. 17, the terminal case 400 of the compressor 100 according to an embodiment of the present disclosure may include a positioning hole 402-3.

The positioning hole 402-3 may include a central hole 402a-3, a first extension hole 402b-3 extending from the central hole 402a-3, and a second extension hole 402c-3 extending from the central hole 402a-3. The central hole 402a-3, the first extension hole 402b-3, and the second extension hole 402c-3 may be connected to each other.

A direction in which the first extension hole 402b-3 extends from the central hole 402a-3 and a direction in which the second extension hole 402c-3 extends from the central hole 402a-3 may form a predetermined angle to each other. FIG. 17 illustrates an example in which the direction in which the first extension hole 402b-3 extends from the central hole 402a-3 and the direction in which the second extension hole 402c-3 extends from the central hole 402a-3 are perpendicular to each other, but the size of the angle is not limited thereto.

As an example, the central hole 402a-3 may be formed in the center of the terminal case 400. As an example, the central hole 402a-3 may pass through the central axis 401 of the terminal case 400 (see FIG. 10, FIG. 11, etc.).

As an example, the central hole 402a-3 may have a substantially circular cross-section. Unlike that illustrated in FIG. 17, the central hole 402a-3 may have a substantially elliptical cross-section.

As an example, the first extension hole 402b-3 may have a substantially rectangular cross-section. Alternatively, the first extension hole 402b-3 may have a cross-section in the shape of a long bar extending from the central hole 402a-3.

As an example, the second extension hole 402c-3 may have a substantially rectangular cross-section. Alternatively, the second extension hole 402c-3 may have a cross-section in the shape of a long bar extending from the central hole 402a-3.

By this structure, the positioning pin T3 of the assembly tool T may be inserted into the positioning hole 402-3 only at a specific position, and efficiently guide the terminal case 400 to the first position with respect to the plurality of external terminals 200.

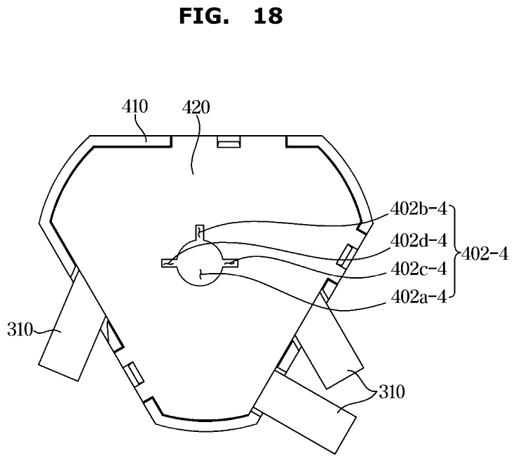

FIG. 18 is a view illustrating the terminal case of the compressor and an example of a positioning hole formed thereon according to an embodiment of the present disclosure.

Referring to FIG. 18, the terminal case 400 of the compressor 100 according to an embodiment of the present disclosure may include a positioning hole 402-4.

The positioning hole 402-4 may include a central hole 402a-4, a first extension hole 402b-4 extending from the central hole 402a-4, a second extension hole 402c-4 extending from the central hole 402a-4, and a third extension hole 402d-4 extending from the central hole 402a-4. The central hole 402a-4, the first extension hole 402b-4, the second extension hole 402c-4, and the third extension hole 402d-4 may be connected to each other.

A direction in which the first extension hole 402b-4 extends from the central hole 402a-4, a direction in which the second extension hole 402c-4 extends from the central hole 402a-4, and a direction in which the third extension hole 402d-4 extends from the central hole 402a-4 may form a predetermined angle to each other. FIG. 18 illustrates an example in which the direction in which the first extension hole 402b-4 extends from the central hole 402a-4 and the direction in which the second extension hole 402c-4 extends from the central hole 402a-4 are perpendicular to each other, but the size of the angle is not limited thereto. FIG. 18 illustrates an example in which the direction in which the first extension hole 402b-4 extends from the central hole 402a-4 and the direction in which the third extension hole 402d-4 extends from the central hole 402a-4 are perpendicular to each other, but the size of the angle is not limited thereto. FIG. 18 illustrates an example in which the second extension hole 402c-4 and the third extension hole 402d-4 are positioned on opposite sides based on the central hole 402a-4 so that the direction in which the second extension hole 402c-4 extends from the central hole 402a-4 and the direction in which the third extension hole 402d-4 extends from the central hole 402 a-4 form an angle of 180 degrees, but the size of the angle is not limited thereto.

As an example, the central hole 402a-4 may be formed in the center of the terminal case 400. As an example, the central hole 402a-4 may pass through the central axis 401 of the terminal case 400 (see FIG. 10, FIG. 11, etc.).

As an example, the central hole 402a-4 may have a substantially circular cross-section. Unlike that illustrated in FIG. 18, the central hole 402a-4 may have a substantially elliptical cross-section.

As an example, the first extension hole 402b-4 may have a substantially rectangular cross-section. Alternatively, the first extension hole 402b-4 may have a cross-section in the shape of a long bar extending from the central hole 402a-4.

As an example, the second extension hole 402c-4 may have a substantially rectangular cross-section. Alternatively, the second extension hole 402c-4 may have a cross-section in the shape of a long bar extending from the central hole 402a-4.

As an example, the third extension hole 402d-4 may have a substantially rectangular cross-section. Alternatively, the third extension hole 402d-4 may have a cross-section in the shape of a long bar extending from the central hole 402a-4.

By this structure, the positioning pin T3 of the assembly tool T may be inserted into the positioning hole 402-4 only at a specific position, and efficiently guide the terminal case 400 to the first position with respect to the plurality of external terminals 200.

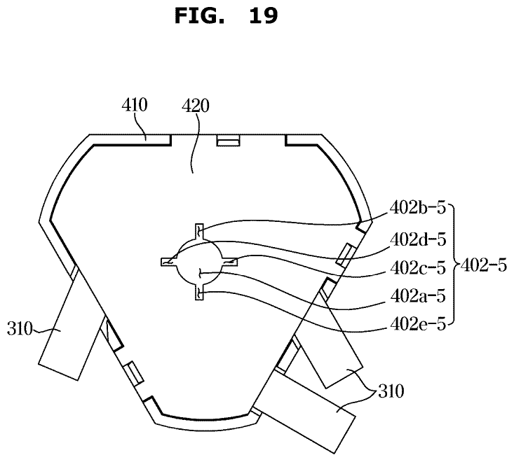

FIG. 19 is a view illustrating the terminal case of the compressor and an example of a positioning hole formed thereon according to an embodiment of the present disclosure.

Referring to FIG. 19, the terminal case 400 of the compressor 100 according to an embodiment of the present disclosure may include a positioning hole 402-5.

The positioning hole 402-5 may include a central hole 402a-5, a first extension hole 402b-5 extending from the central hole 402a-5, a second extension hole 402c-5 extending from the central hole 402a-5, a third extension hole 402d-5 extending from the central hole 402a-5, and a fourth extension hole 402e-5 extending from the central hole 402a-5. The central hole 402a-5, the first extension hole 402b-5, the second extension hole 402c-5, the third extension hole 402d-5, and the fourth extension hole 402e-5 may be connected to each other.

A direction in which the first extension hole 402b-5 extends from the central hole 402a-5, a direction in which the second extension hole 402c-5 extends from the central hole 402a-5, a direction in which the third extension hole 402d-5 extends from the central hole 402a-5, and a direction in which the fourth extension hole 402e-5 extends from the central hole 402a-5 may form a predetermined angle to each other. FIG. 19 illustrates an example in which the direction in which each of the first extension hole 402b-5, the second extension hole 402c-5, the third extension hole 402d-5, and the fourth extension hole 402e-5 extends from the central hole 402a-5 is perpendicular to the direction in which the extension hole adjacent to each of the extension holes extends from the central hole 402a-5, but the size of the angle is not limited thereto.

As an example, the central hole 402a-5 may be formed in the center of the terminal case 400. As an example, the central hole 402a-5 may pass through the central axis 401 of the terminal case 400 (see FIG. 10, FIG. 11, etc.).

As an example, the central hole 402a-5 may have a substantially circular cross-section. Unlike that illustrated in FIG. 19, the central hole 402a-5 may have a substantially elliptical cross-section.

As an example, the first extension hole 402b-5 may have a substantially rectangular cross-section. Alternatively, the first extension hole 402b-5 may have a cross-section in the shape of a long bar extending from the central hole 402a-5.

As an example, the second extension hole 402c-5 may have a substantially rectangular cross-section. Alternatively, the second extension hole 402c-5 may have a cross-section in the shape of a long bar extending from the central hole 402a-5.

As an example, the third extension hole 402d-5 may have a substantially rectangular cross-section. Alternatively, the third extension hole 402d-5 may have a cross-section in the shape of a long bar extending from the central hole 402a-5.

As an example, the fourth extension hole 402e-5 may have a substantially rectangular cross-section. Alternatively, the fourth extension hole 402e-5 may have a cross-section in the shape of a long bar extending from the central hole 402a-5.

By this structure, the positioning pin T3 of the assembly tool T may be inserted into the positioning hole 402-5 only at a specific position, and efficiently guide the terminal case 400 to the first position with respect to the plurality of external terminals 200.

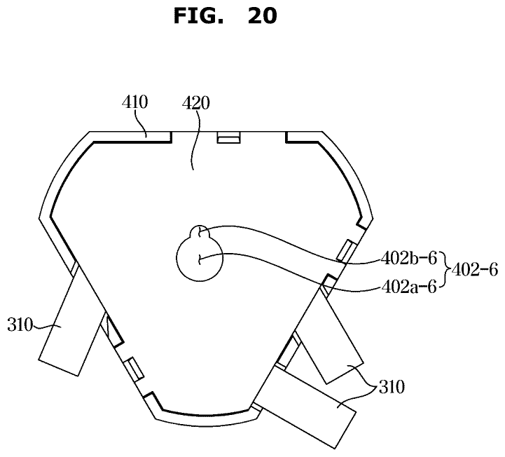

FIG. 20 is a view illustrating the terminal case of the compressor and an example of a positioning hole formed thereon according to an embodiment of the present disclosure.

Referring to FIG. 20, the terminal case 400 of the compressor 100 according to an embodiment of the present disclosure may include a positioning hole 402-6.

The positioning hole 402-6 may include a central hole 402a-6 and an extension hole 402b-6 extending from the central hole 402a-6. The central hole 402a-6 and the extension hole 402b-6 may be connected to each other.

As an example, the central hole 402a-6 may be formed in the center of the terminal case 400. As an example, the central hole 402a-6 may pass through the central axis 401 of the terminal case 400 (see FIG. 10, FIG. 11, etc.).

As an example, the central hole 402a-6 may have a substantially circular cross-section. Unlike that illustrated in FIG. 20, the central hole 402a-6 may have a substantially elliptical cross-section.

As an example, the extension hole 402b-6 may have a cross-section substantially in the shape of a portion of a circle (e.g., a circular sector, a circular segment, etc.).

As an example, the positioning hole 402-6 may have a shape in which portions of circles having different diameters overlap each other.

By this structure, the positioning pin T3 of the assembly tool T may be inserted into the positioning hole 402-6 only at a specific position, and efficiently guide the terminal case 400 to the first position with respect to the plurality of external terminals 200.

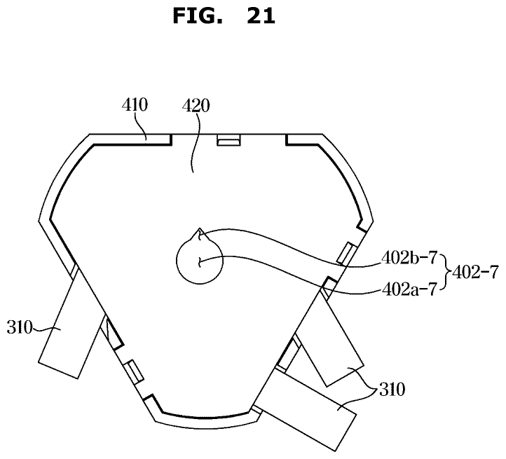

FIG. 21 is a view illustrating the terminal case of the compressor and an example of a positioning hole formed thereon according to an embodiment of the present disclosure.

Referring to FIG. 21, the terminal case 400 of the compressor 100 according to an embodiment of the present disclosure may include a positioning hole 402-7.

The positioning hole 402-7 may include a central hole 402a-7 and an extension hole 402b-7 extending from the central hole 402a-7. The central hole 402a-7 and the extension hole 402b-7 may be connected to each other.

As an example, the central hole 402a-7 may be formed in the center of the terminal case 400. As an example, the central hole 402a-7 may pass through the central axis 401 of the terminal case 400 (see FIG. 10, FIG. 11, etc.).

As an example, the central hole 402a-7 may have a substantially circular cross-section. Unlike that illustrated in FIG. 21, the central hole 402a-7 may have a substantially elliptical cross-section.

As an example, the extension hole 402b-7 may have a substantially triangular cross-section.

By this structure, the positioning pin T3 of the assembly tool T may be inserted into the positioning hole 402-7 only at a specific position, and efficiently guide the terminal case 400 to the first position with respect to the plurality of external terminals 200.

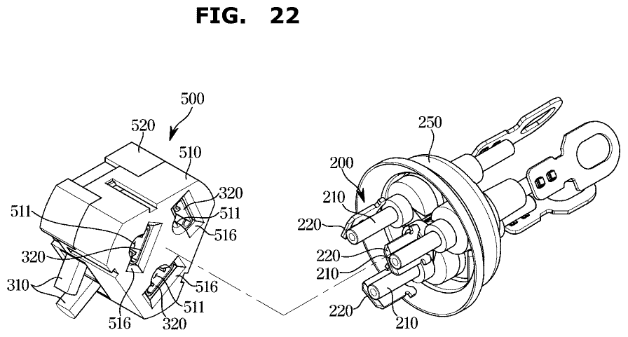

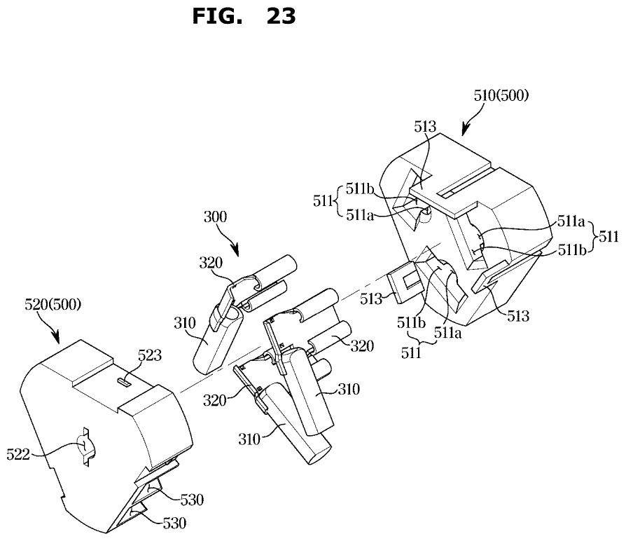

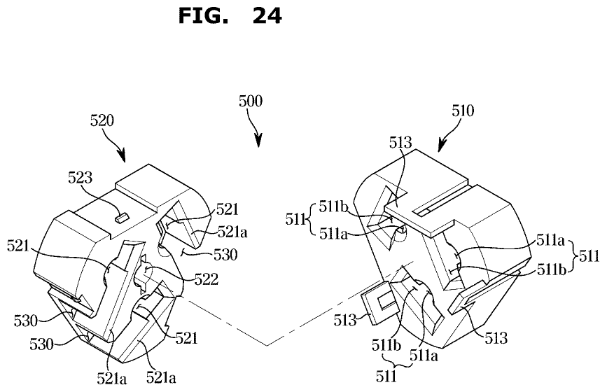

FIG. 22 is a view illustrating the external terminal, the internal terminal, and a terminal case of the compressor according to an embodiment of the present disclosure. FIG. 23 is an exploded view illustrating the internal terminal and the terminal case of the compressor according to an embodiment of the present disclosure. FIG. 24 is an exploded view illustrating a case body and a case cover of the terminal case of the compressor according to an embodiment of the present disclosure.

Components of the compressor 100 according to an embodiment of the present disclosure illustrated in FIGS. 22 to 24 corresponding to those in the embodiments illustrated in FIGS. 1 to 21 may be given the same reference numerals, and descriptions thereof may not be repeated.

Referring to FIGS. 22 to 24, the compressor 100 according to an embodiment of the present disclosure may include a terminal case 500. The terminal case 500 may be disposed inside the housing 103. The terminal case 500 may support the plurality of internal terminals 300. The terminal case 500 may cover the plurality of internal terminals 300. The terminal case 500 may accommodate the plurality of internal terminals 300.

The terminal holder 320 of each of the plurality of internal terminals 300 may be disposed inside a terminal case 500. The terminal case 500 may cover the terminal holder 320 of each of the plurality of internal terminals 300.

When the terminal holder 320 and the connection plate 220 are coupled, the connection plate 220 may be disposed inside the terminal case 500. When the terminal holder 320 and connection plate 220 are coupled, the terminal case 500 may cover the connection plate 220. The connection plate 220 of each of the plurality of external

terminals 200 and the terminal holder 320 of each of the plurality of internal terminals 300 may be coupled to each other inside the terminal case 500.

The terminal case 500 may include a guide hole 511. The guide hole 511 may be provided such that the terminal holder 320 included in each of the plurality of internal terminals 300 may be inserted therein. The guide hole 511 may be provided such that the connection plate 220 included in each of the plurality of external terminals 200 may be inserted therein. For example, the terminal holder 320 may be inserted into one side of the guide hole 511, and the connection plate 220 may be inserted into the other side of the guide hole 511.

As the terminal holder 320 is inserted into the guide hole 511, the internal terminal 300 may be coupled to the terminal case 500. As the connection plate 220 is inserted into the guide hole 511, the external terminal 200 may be coupled to the terminal case 500.

The guide hole 511 may be provided in plurality. In each of a plurality of the guide holes 511, the connection plate 220 of one external terminal among the plurality of external terminals 200 and the terminal holder 320 of one internal terminal among the plurality of internal terminals 300 may be inserted. A number of the guide holes 511 may be equal to the number of the external terminals 200 and the number of the internal terminals 300, and for example, the terminal case 500 may include the three guide holes 511.

One sides on which the terminal holders 320 of the plurality of internal terminals 300 are inserted into the plurality of guide holes 511, respectively, may be equal to each other. The other sides on which the connection plates 220 of the plurality of external terminals 200 are inserted into the plurality of guide holes 511, respectively, may be equal to each other.

The guide hole 511 may be provided such that the connection plate 220 and the terminal holder 320 may be combinable with each other inside the terminal case 500. The plurality of guide holes 511 may each guide the terminal holders 320 such that the terminal holders 320 of the plurality of internal terminals 300 are inserted therein. Each of the plurality of guide holes 511 may guide the connection plate 220 of each of the plurality of external terminals 200 so that the connection plate 220 may be inserted into the guide hole 511 and combinable with the terminal holder 320.

As such, as the connection plate 220 and the terminal holder 320 are coupled to each other inside the guide hole 511 formed inside the terminal case 500, the connection plate 220 and the terminal holder 320 may be effectively protected from external high temperatures or foreign substances.

The terminal case 500 may include a first inclined surface formed on a perimeter of the guide hole 511 in a direction in which the terminal holder 320 is inserted into the guide hole 511. The first inclined surface may be formed such that a width of the guide hole 511 becomes narrower as the terminal holder 320 directs to the direction of being inserted into the guide hole 511.

The terminal case 500 may include a second inclined surface 516 formed on the perimeter of the guide hole 511 in a direction in which the connection plate 220 is inserted into the guide hole 511. The second inclined surface 516 may be formed such that a width of the guide hole 511 becomes narrower as the connection plate 220 directs to the direction of being inserted into the guide hole 511.

The plurality of guide holes 511 may be partitioned from each other. Accordingly, the terminal holder 320 and the connection plate 220 inserted into the guide holes 511 different from each other may be spaced apart from each other, and short circuits due to contact between terminals inserted into the guide holes 511 different from each other may be effectively prevented.

According to an embodiment, each of the plurality of guide holes 511 may be spaced apart from a central axis of the terminal case 500. The central axis of the terminal case 500 may be defined as an axis passing through a center of the terminal case 500 in a direction in which the terminal holder 320 and the connection plate 220 are inserted into the guide hole 511.

According to an embodiment, the terminal holder 320 may be fixed inside the guide hole 511. The guide hole 511 may be formed to prevent the terminal holder 320 from moving inside the guide hole 511. Inside the guide hole 511, the terminal holder 320 may be prevented from moving by coming into contact with an inner surface of the terminal case 500 in at least two directions. Accordingly, the terminal holder 320 and the connection plate 220 may be easily coupled only by inserting the connection plate 220 into the guide hole 511 into which the terminal holder 320 is inserted.

By using the structure of the terminal case 500 as described above, it is possible to couple the plurality of external terminals 200 and the plurality of internal terminals 300 simultaneously, and the coupling process may be easily and efficiently performed. Furthermore, the process of coupling the plurality of external terminals 200 and the plurality of internal terminals 300 may be easily automated.

According to an embodiment, when the connection plate 220 is inserted into the guide hole 511, at least a portion of the external terminal lead 210 may also be inserted into the guide hole 511. For example, the external terminal lead 210 may penetrate one surface of the terminal case 500 adjacent to the housing 103 and be inserted into the guide hole 511.

According to an embodiment, the internal terminal lead 310 may penetrate the terminal case 500. The terminal case 500 may include an internal terminal lead hole 530 penetrated by the internal terminal lead 310. The internal terminal lead hole 530 may be connected to the guide hole 511.

For example, the internal terminal lead hole 530 may be formed on a case cover 520. The internal terminal lead hole 530 may be formed on a peripheral surface of the case cover 520. Herein, the peripheral surface of the case cover 520 may include a peripheral surface of the case cover 520 directing to a direction different from the direction in which the terminal holder 320 and the connection plate 220 are inserted.

The internal terminal lead hole 530 may extend in one direction from the peripheral surface of the case cover 520 toward the inside of the case cover 520. A direction in which the internal terminal lead hole 530 extends from the peripheral surface of the case cover 520 and a direction in which the guide hole 511 extends may be perpendicular to each other. For example, the direction in which the internal terminal lead hole 530 extends from the peripheral surface of the case cover 520 and the direction in which the guide hole 511 extends may be substantially perpendicular.

The terminal case 500 may include a number of the internal terminal lead holes 530 corresponding to the number of the external terminals 200 (e.g., three). As an example, the plurality of internal terminal lead holes 530 may be spaced and partitioned from each other.

In order to prevent connection defects between the plurality of external terminals 200 and the plurality of internal terminals 300, the plurality of external terminals 200 may be inserted into the plurality of guide holes 511 and coupled to the plurality of internal terminals 300 only when the terminal case 500 is in one predetermined first position with respect to the plurality of external terminals 200, and when the terminal case 500 is in the second position rotated from the first position, the plurality of external terminals 200 may not be insertable into the plurality of guide holes 511 and may not be combinable with the plurality of internal terminals 300.

Each of the plurality of guide holes 511 may include a lead region 511a provided such the external terminal lead 210 is inserted thereinto, and a connection region 511b provided such the terminal holder 320 and the connection plate 220 are inserted thereinto and connected to each other. When the terminal holder 320 and the connection plate 220 are coupled inside the guide hole 511, the external terminal lead 210 may be disposed in the lead region 511a of the guide hole 511, and the terminal holder 320 and the connection plate 220 may be disposed in the connection region 511b of the guide hole 511.

In this embodiment, a feature and function resulting from the lead region 511a and the connection region 511b of the guide hole 511 are almost the same as or similar to the feature and function resulting from the lead region 411a and the connection region 411b of the guide hole 411 in the embodiments described with reference to FIGS. 4 to 14. For example, in some of the plurality of guide holes 511, the connection region 511b may be closer to the central axis 401 of the terminal case 500 than the lead region 511a. Also, in the other of the plurality of guide holes 511, the lead region 511a may be closer to the central axis 401 of the terminal case 500 than the connection region 511b. Therefore, the connection plate 220 and the external terminal lead 210 may be inserted into the guide hole 511 only when the terminal case 500 is in the one predetermined first position with respect to the plurality of external terminals 200, and the plurality of external terminals 200 and the plurality of internal terminals 300 may be connected to each other.

In order to improve the efficiency of the process of connecting the external terminal 200 and the internal terminal 300, the terminal case 500 may include a positioning hole 522. The positioning hole 522 may be provided such that the assembly tool T (see FIGS. 13 and 14) is inserted into the positioning hole 522 to guide the terminal case 500 to the first position with respect to the plurality of external terminals 200.

As an example, the positioning hole 522 may be formed at least on the case cover 520, and in various embodiments, the positioning hole 522 may also be formed in a case body 510.

According to an embodiment, the terminal case 500 may include the case body 510 and the case cover 520.

The case body 510 may be configured to support the plurality of internal terminals 300. The guide hole 511 may be formed on the case body 510. That is, the plurality of guide holes 511 may be formed on the case body 510.

The plurality of guide holes 511 may extend from one surface of the case body 510 adjacent to the case cover 520 to the other surface. The terminal holder 320 may be inserted on one side adjacent to the case cover 520, and the connection plate 220 may be inserted on the other side opposite thereto.

The case cover 520 may cover the case body 510. The case cover 520 may cover the case body 510 from one side. The case cover 520 may cover the plurality of guide holes 511. The case cover 520 may cover the terminal holder 320 of each of the plurality of internal terminals 300.

The case cover 520 may cover the case body 510, the plurality of guide holes 511, and the terminal holders 320 of the plurality of internal terminals 300 from one side on which the terminal holders 320 are inserted into the plurality of guide holes 511.

The case cover 520 may also cover at least a portion of the internal terminal lead 310 of each of the plurality of internal terminals 300.

The case cover 520 may be coupled to the case body 510. The case cover 520 may cover the case body 510, the plurality of guide holes 511, and the terminal holders 320 of the plurality of internal terminals 300 by being coupled to the case body 510.

For example, the case cover 520 may be coupled to the case body 510 from the outside. An outer couple part 523 of the case cover 520 may be coupled to an outer couple part 513 formed on a peripheral surface of the case body 510. As an example, the outer couple part 523 of the case cover 520 may have a protrusion shape of protruding from the peripheral surface of the case cover 520 to be caught on a hole formed on the outer couple part 513 of the case body 510, so that the case body 510 and the case cover 520 may be coupled to each other.

As an example, the outer coupling part 513 of the case body 510 may come into contact with the peripheral surface of the case cover 520.

However, the configuration for coupling the case cover 520 and the case body 510 is not limited thereto, and according to various embodiments, the case cover 520 may be coupled to the case body 510 by various methods, such as screw fastening.

The case cover 520 may include a cover groove 521 into which a portion of each of the plurality of internal terminals 300 may be inserted. A portion of the terminal holder 320 included in each of the plurality of internal terminals 300 may be inserted into the cover groove 521.

For example, a portion of the internal terminal lead 310 included in each of the plurality of internal terminals 300 may be inserted into the cover groove 521. The cover groove 521 may be connected to the internal terminal lead hole 530.

For example, a portion of the terminal holder 320 included in each of the plurality of internal terminals 300 may be inserted into the cover groove 521. One portion of the terminal holder 320 may be inserted into the cover groove 521, and the other portion of the terminal holder 320 may be inserted into the guide hole 511. The cover groove 521 may be connected to the guide hole 511.

The cover groove 521 may have a shape of being recessed concavely from one surface of the case cover 520 facing the case body 510.

The case cover 520 may include an inclined surface 521a provided on a perimeter of the cover groove 521. The inclined surface 521a may be formed on the perimeter of the cover groove 521 on a side of the case cover 520 adjacent to the case body 510. The inclined surface 521a may be formed on the perimeter of the cover groove 521 on a side where a portion of the terminal holder 320 is inserted into the cover groove 521. The inclined surface 521a may be formed such that a width of the cover groove 521 becomes narrower as a portion of the terminal holder 320 directs to a direction of being inserted into the cover groove 521. The inclined surface 521a may be provided to guide a portion of the terminal holder 320 to be inserted into the cover groove 521.

According to an embodiment, a thickness of the case cover 520 and a thickness of the case body 510 may be almost the same. Herein, the thickness may be a thickness measured in a direction in which the case cover 520 and the case body 510 face each other, which may be substantially the same as a thickness measured in a direction in which the terminal holder 320 is inserted into the guide hole 511. As such, as the case cover 520 has the thickness almost identical to the thickness of the case body 510, in the process of coupling the external terminal 200 and the internal terminal 300, the case cover 520 may be prevented from being separated from the case body 510 by a repulsive force from the external terminal 200.

In this embodiment, as the cover groove 521 into which a portion of the terminal holder 320 is inserted and the internal terminal lead hole 530 through which the internal terminal lead 310 penetrates are formed on the case cover 520, the case cover 520 may have the thickness thicker than the case cover 420 according to the embodiments of FIGS. 4 to 14.

The embodiments, in which the plurality of internal terminals 300 and the terminal case 400 are disposed inside the housing 103 of the compressor 100 and the plurality of external terminals 200 penetrates the housing 103 and is fixed to the housing 103, have been described above with reference to FIGS. 1 to 24, but the arrangements of the plurality of internal terminals 300, the terminal case 400 and the plurality of external terminals 200 are not limited thereto, and in various embodiments, each component may be disposed in various locations.

The embodiments, in which the plurality of internal terminals 300 is connected to the motor 70 and the plurality of external terminals 200 is connected to an external power source, have been described above with reference to FIGS. 1 to 24, but in various embodiments, the plurality of internal terminals 300 and the plurality of external terminals 200 may be connected to various components or various power sources.

In various embodiments of the present disclosure, components of the internal terminals, the external terminals, and the terminal case supporting the same may be included in various products for forming circuits by connecting different terminals.

A compressor according to an embodiment of the present disclosure may include a motor, a housing configured to accommodate the motor, a plurality of external terminals connected to an external power source disposed outside the housing, a plurality of internal terminals disposed inside the housing and electrically connected to the motor, the plurality of internal terminals configured to be connected correspondingly to the plurality of external terminals, and a terminal case disposed inside the housing and configured to support the plurality of internal terminals. Each of the plurality of external terminals may include a connection plate. Each of the plurality of internal terminals may include a terminal holder configured such that the connection plate of a corresponding external terminal among the plurality of external terminals is fitted and coupled thereto. The terminal case may include a plurality of guide holes configured such that the terminal holder included in each of the plurality of

internal terminals is inserted from one side thereof and the connection plate included in each of the plurality of external terminals is inserted from another side, whereby each of the plurality of guide holes may guide the connection plate of each of the plurality of external terminals so that the connection plate is coupleable to the terminal holder inside the terminal case.

The terminal case may include a case body on which the plurality of guide holes is formed, and a case cover coupled to the case body to cover the plurality of guide holes.

The case cover may be configured to cover the plurality of guide holes from the one side into which the terminal holders each included in the plurality of internal terminals are inserted into the plurality of guide holes.

Each of the plurality of guide holes may extend from one surface of the case body adjacent to the case cover to another surface.

The case cover may include a cover groove into which a portion of each of the plurality of internal terminals is inserted.

A portion of the terminal holder included in each of the plurality of internal terminals may be inserted into the cover groove.

Based on the terminal case being positioned at one predetermined first position with respect to the plurality of external terminals, the terminal holders of the plurality of internal terminals inserted into the plurality of guide holes may be correspondingly coupleable to the connection plates of the plurality of external terminals. Based on the terminal case being positioned at a second position rotated from the first position with respect to the plurality of external terminals, the terminal holder of each of the plurality of internal terminals inserted into the plurality of guide holes may be disposed to be misaligned with the connection plate of each of the plurality of external terminals.

Based on the terminal case being positioned at the first position with respect to the plurality of external terminals, the connection plate of each of the plurality of external terminals may be correspondingly positioned to be insertable into a corresponding guide hole among the plurality of guide holes. Based on the terminal case being positioned at the second position with respect to the plurality of external terminals, the connection plate of each of the plurality of external terminals may be disposed to be misaligned so as not to be inserted into each of the plurality of guide holes.

The terminal case may further include a positioning hole provided such that an assembly tool is inserted thereinto to guide the terminal case to the first position with respect to the plurality of external terminals.

Each of the plurality of external terminals may further include an external terminal lead coupled to one surface of the connection plate. Each of the plurality of guide holes may include a lead region provided such the external terminal lead is inserted thereinto, and a connection region provided such the terminal holder and the connection plate are inserted thereinto and connected to each other.

At least one of the plurality of guide holes may have the connection region closer to a central axis of the terminal case than the lead region. At least another of the plurality of guide holes may have the lead region closer to the central axis of the terminal case than the connection region.

Each of the plurality of internal terminals may further include an internal terminal lead coupled to a side of the terminal holder opposite to the guide hole. The terminal case may further include an internal terminal lead hole penetrated by the internal terminal lead.

The internal terminal lead hole may be connected to the guide hole.

The terminal case may further include an inclined surface provided on a perimeter of the guide hole. The inclined surface may be formed such that a width of the guide hole becomes narrower as the terminal holder directs to a direction of being inserted into the guide hole.

The terminal holder may be configured to press both surfaces of the connection plate when the terminal holder and the connection plate are coupled.

A compressor according to an embodiment of the present disclosure may include a motor, a housing configured to accommodate the motor, a plurality of external terminals connected to an external power source disposed outside the housing, a plurality of internal terminals disposed inside the housing and configured to be connected correspondingly to the plurality of external terminals, and a terminal case disposed inside the housing and configured to support the plurality of internal terminals. Each of the plurality of internal terminals may include an internal terminal

lead electrically connected to the motor, and a terminal holder connected to the internal terminal lead and configured such that a corresponding external terminal among the plurality of external terminals is fitted and coupled thereto. The terminal case may include a plurality of guide holes provided such that the terminal holders are inserted thereinto to fix the plurality of internal terminals. The guide hole may be provided such that the plurality of external terminals is insertable from another side so that the plurality of external terminals is coupleable to the terminal holder included in a corresponding internal terminal among the plurality of internal terminals inside the guide hole.

The terminal case may include a case body on which the plurality of guide holes are formed, and a case cover coupled to the case body to cover the plurality of guide holes.

Each of the plurality of guide holes may extend from one surface of the case body adjacent to the case cover to another surface.

The plurality of guide holes may be partitioned from each other.

A compressor according to an embodiment of the present disclosure may include a housing, a plurality of first terminals fixed to the housing, a plurality of second terminals configured to be connected correspondingly to the plurality of first terminals, and a terminal case configured to accommodate the plurality of second terminals. Each of the plurality of first terminals may include a connection plate. Each of the plurality of second terminals may include a terminal holder configured such that the connection plate of a corresponding first terminal among the plurality of first terminals is fitted and coupled thereto. The terminal case may include a plurality of guide holes configured such that the terminal holder included in each of the plurality of second terminals is inserted thereinto from one side and the connection plate included in each of the plurality of first terminals is inserted thereinto from the other side, and the plurality of guide holes may guide the plurality of first terminals so that the connection plates are coupleable to the terminal holders inside the terminal case.

According to the present disclosure, a compressor includes a plurality of external terminals including a connection plate and a plurality of internal terminals including a terminal holder into which the connection plate is fitted and coupled, so that the external terminals and the internal terminals can be firmly coupled.

According to the present disclosure, as the terminal holder of each of the plurality of internal terminals is inserted into a guide hole formed on the terminal case and the connection plate of each of the plurality of external terminals is guided by the guide hole, the terminal holder and the connection plate can be easily coupled inside the guide hole, so that a process of coupling the plurality of external terminals and the plurality of internal terminals can be performed efficiently, and the process of coupling the plurality of external terminals and the plurality of internal terminals can be easily automated.

According to the present disclosure, the plurality of internal terminals and the plurality of external terminals can be protected from foreign substances and high temperatures inside the compressor by being coupled to each other inside the terminal case.

Effects according to the present disclosure are not limited to the effects mentioned above, and other effects not mentioned will be clearly understood by those skilled in the art to which the present disclosure belongs from the fallowing description.

The foregoing has illustrated and described specific embodiments. However, it should be understood by those of skilled in the art that the present disclosure is not limited to the above-described embodiments, and various changes and modifications may be made without departing from the technical idea of the present disclosure described in the following claims.

1. A compressor comprising:
a motor;
a housing configured to accommodate the motor;
a plurality of external terminals connectable to an external power source outside the housing, wherein each of the plurality of external terminals includes a connection plate; and
a plurality of internal terminals inside the housing and electrically connected to the motor, wherein each of the plurality of internal terminals includes a terminal holder configured such that the connection plate of a corresponding external terminal of the plurality of external terminals is coupled to the terminal holder; and
a terminal case inside the housing, and configured to support the plurality of internal terminals,
wherein the terminal case comprises a plurality of guide holes, each guide hole being configured such that the terminal holder of a corresponding internal terminal of the plurality of internal terminals is insertable into the guide hole through one side of the guide hole to be supported by the terminal case, and the connection plate of a corresponding external terminal of the plurality of external terminals is insertable into the guide hole through another side of the guide hole to be coupleable to the terminal holder inside the terminal case.

2. The compressor according to claim 1, wherein
the terminal case includes:
a case body on which the plurality of guide holes is formed; and
a case cover coupleable to the case body to cover the plurality of guide holes.

3. The compressor according to claim 2, wherein
the case cover is configured to cover the plurality of guide holes from a side of the plurality of guide holes from which the terminal holders of the plurality of internal terminals are insertable into the plurality of guide holes.

4. The compressor according to claim 2, wherein
each of the plurality of guide holes extends from one surface of the case body adjacent to the case cover to another surface.

5. The compressor according to claim 2, wherein
the case cover includes a cover groove into which a portion of each internal terminal of the plurality of internal terminals is insertable.

6. The compressor according to claim 5, wherein
a portion of the terminal holder of each of the plurality of internal terminals is insertable into the cover groove.

7. The compressor according to claim 1, wherein
based on the terminal case being positioned at a first position with respect to the plurality of external terminals, when the terminal holders of the plurality of internal terminals are inserted into the plurality of guide holes, the terminal holders of the plurality of internal terminals are respectively couplable to the connection plates of the corresponding external terminals of the plurality of external terminals, and
based on the terminal case being positioned at a second position rotated from the first position with respect to the plurality of external terminals, when terminal holders of the plurality of internal terminals are inserted into the plurality of guide holes, the terminal holders of the plurality of internal terminals are misaligned with the connection plates of the corresponding external terminals of the plurality of external terminals.

8. The compressor according to claim 7, wherein
based on the terminal case being positioned at the first position with respect to the plurality of external terminals, the connection plate of each of the plurality of external terminals is positioned to be insertable into a corresponding guide hole of the plurality of guide holes, and
based on the terminal case being positioned at the second position with respect to the plurality of external terminals, the connection plate of each of the plurality of external terminals is misaligned so as not to be insertable into each of the plurality of guide holes.

9. The compressor according to claim 7, wherein
the terminal case further includes a positioning hole such that an assembly tool is insertable in the positioning hole to guide the terminal case to the first position with respect to the plurality of external terminals.

10. The compressor according to claim 1, wherein
the plurality of external terminals respectively include an external terminal lead, and the external terminal lead of each external terminal is coupled to a surface of the connection plate of the external terminal, and
the plurality of guide holes respectively include:
a lead region configured such that the external terminal lead is insertable thereinto, and
a connection region configured such that the terminal holder and the connection plate are insertable thereinto.

11. The compressor according to claim 10, wherein
at least one guide hole of the plurality of guide holes has the connection region closer to a central axis of the terminal case than the lead region, and
at least another guide hole of the plurality of guide holes has the lead region closer to the central axis of the terminal case than the connection region.

12. The compressor according to claim 1, wherein
the plurality of internal terminals respectively include an internal terminal lead, and the internal terminal lead of each internal terminal is coupled to the terminal holder of the internal terminal, and
the terminal case further includes a plurality of internal terminal lead holes respectively penetratable by the internal terminal lead of each of the plurality of internal terminals.

13. The compressor according to claim 12, wherein
the plurality of internal terminal lead holes is connected to the plurality of guide holes.

14. The compressor according to claim 1, wherein
the terminal case further includes a plurality of inclined surfaces respectively corresponding to the plurality of guide holes, with each inclined surface of the plurality of inclined surfaces being on a perimeter of the corresponding guide hole, and
each inclined surface of the plurality of inclined surfaces is formed such that a width of the corresponding guide hole becomes narrower as the terminal holder corresponding to the guide hole directs to a direction of being inserted into the guide hole.

15. The compressor according to claim 1, wherein
for each guide hole of the plurality of guide holes, the terminal holder is configured to press both surfaces of the connection plate when the terminal holder and the connection plate are coupled.
